(19) United States
(12) Patent Application Publication
(10) Pub. No.: US 2025/0244461 A1
(43) Pub. Date: Jul. 31, 2025

(54) MULTIPATH RADIO PROPAGATION REPORTING

(71) Applicant: QUALCOMM Incorporated, San Diego, CA (US)

(72) Inventors: Mohammed Ali Mohammed HIRZALLAH, San Marcos, CA (US); Xiaoxia ZHANG, San Diego, CA (US); Rajat PRAKASH, San Diego, CA (US); Marwen ZORGUI, San Diego, CA (US); Mohammad Tarek FAHIM, San Diego, CA (US); Srinivas YERRAMALLI, San Diego, CA (US)

(21) Appl. No.: 18/422,671

(22) Filed: Jan. 25, 2024

(51) Int. Cl. G01S 13/46; G01S 7/00

(52) U.S. Cl. CPC G01S 13/46; G01S 7/006; G01S 2013/462

(57) ABSTRACT

In an aspect, a sensing node may obtain one or more multipath measurements of one or more sensing signals associated with one or more radio propagation paths. The sensing node may obtain radio propagation paths information associated with the one or more radio propagation paths based on the one or more multipath measurements. The sensing node may report, to a sensing entity, the one or more multipath measurements and the radio propagation paths information associated with the one or more radio propagation paths.

### BACKGROUND OF THE DISCLOSURE

### 1. Field of the Disclosure

Aspects of the disclosure relate generally to wireless technologies.

### 2. Description of the Related Art

Wireless communication systems have developed through various generations, including a first-generation analog wireless phone service (1G), a second-generation (2G) digital wireless phone service (including interim 2.5G and 2.75G networks), a third-generation (3G) high-speed data, Internet-capable wireless service and a fourth-generation (4G) service (e.g., Long Term Evolution (LTE) or WiMax). There are presently many different types of wireless communication systems in use, including cellular and personal communications service (PCS) systems. Examples of known cellular systems include the cellular analog advanced mobile phone system (AMPS), and digital cellular systems based on code division multiple access (CDMA), frequency division multiple access (FDMA), time division multiple access (TDMA), the Global System for Mobile communications (GSM), etc.

A fifth generation (5G) wireless standard, referred to as New Radio (NR), enables higher data transfer speeds, greater numbers of connections, and better coverage, among other improvements. The 5G standard, according to the Next Generation Mobile Networks Alliance, is designed to provide higher data rates as compared to previous standards, more accurate positioning (e.g., based on reference signals for positioning (RS-P), such as downlink, uplink, or sidelink positioning reference signals (PRS)), and other technical enhancements. These enhancements, as well as the use of higher frequency bands, advances in PRS processes and technology, and high-density deployments for 5G, enable highly accurate 5G-based positioning.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In an aspect, a method of wireless communication performed by a sensing node includes obtaining one or more multipath measurements of one or more sensing signals associated with one or more radio propagation paths; and obtaining radio propagation paths information associated with the one or more radio propagation paths based on the one or more multipath measurements.

In an aspect, a method of wireless communication performed by a sensing entity includes transmitting a configuration for reporting multipath measurements of one or more sensing signals and radio propagation paths information associated with one or more radio propagation paths; and receiving a report including the multipath measurements and the radio propagation paths information associated with the one or more radio propagation paths.

In an aspect, a method of wireless communication performed by a sensing node includes obtaining one or more multipath measurements of one or more sensing signals reflected from a target object; and reporting one or more target path line-of-sight (LOS) indicators associated with the one or more multipath measurements, wherein the one or more target path LOS indicators indicate a likelihood that a target path provides a LOS path between the target object and the sensing node.

In an aspect, a sensing node includes one or more memories; one or more transceivers; and one or more processors communicatively coupled to the one or more memories and the one or more transceivers, the one or more processors, either alone or in combination, configured to: obtain one or more multipath measurements of one or more sensing signals associated with one or more radio propagation paths; and obtain radio propagation paths information associated with the one or more radio propagation paths based on the one or more multipath measurements.

In an aspect, a sensing entity includes one or more memories; one or more transceivers; and one or more processors communicatively coupled to the one or more memories and the one or more transceivers, the one or more processors, either alone or in combination, configured to: transmit, via the one or more transceivers, a configuration for reporting multipath measurements of one or more sensing signals and radio propagation paths information associated with one or more radio propagation paths; and receive, via the one or more transceivers, a report including the multipath measurements and the radio propagation paths information associated with the one or more radio propagation paths.

In an aspect, a sensing node includes one or more memories; one or more transceivers; and one or more processors communicatively coupled to the one or more memories and the one or more transceivers, the one or more processors, either alone or in combination, configured to: obtain one or more multipath measurements of one or more sensing signals reflected from a target object; and report, via the one or more transceivers, one or more target path line-of-sight (LOS) indicators associated with the one or more multipath measurements, wherein the one or more target path LOS indicators indicate a likelihood that a target path provides a LOS path between the target object and the sensing node.

In an aspect, a sensing node includes means for obtaining one or more multipath measurements of one or more sensing signals associated with one or more radio propagation paths; and means for obtaining radio propagation paths information associated with the one or more radio propagation paths based on the one or more multipath measurements.

In an aspect, a sensing entity includes means for transmitting a configuration for reporting multipath measurements of one or more sensing signals and radio propagation paths information associated with one or more radio propagation paths; and means for receiving a report including the multipath measurements and the radio propagation paths information associated with the one or more radio propagation paths.

In an aspect, a sensing node includes means for obtaining one or more multipath measurements of one or more sensing signals reflected from a target object; and means for reporting one or more target path line-of-sight (LOS) indicators associated with the one or more multipath measurements, wherein the one or more target path LOS indicators indicate a likelihood that a target path provides a LOS path between the target object and the sensing node.

In an aspect, a non-transitory computer-readable medium stores computer-executable instructions that, when executed by a sensing node, cause the sensing node to: obtain one or more multipath measurements of one or more sensing signals associated with one or more radio propagation paths; and obtain radio propagation paths information associated with the one or more radio propagation paths based on the one or more multipath measurements.

In an aspect, a non-transitory computer-readable medium stores computer-executable instructions that, when executed by a sensing entity, cause the sensing entity to: transmit a configuration for reporting multipath measurements of one or more sensing signals and radio propagation paths information associated with one or more radio propagation paths; and receive a report including the multipath measurements and the radio propagation paths information associated with the one or more radio propagation paths.

In an aspect, a non-transitory computer-readable medium stores computer-executable instructions that, when executed by a sensing node, cause the sensing node to: obtain one or more multipath measurements of one or more sensing signals reflected from a target object; and report one or more target path line-of-sight (LOS) indicators associated with the one or more multipath measurements, wherein the one or more target path LOS indicators indicate a likelihood that a target path provides a LOS path between the target object and the sensing node.

Other objects and advantages associated with the aspects disclosed herein will be apparent to those skilled in the art based on the accompanying drawings and detailed description.

### BRIEF DESCRIPTION OF THE DRAWINGS

The accompanying drawings are presented to aid in the description of various aspects of the disclosure and are provided solely for illustration of the aspects and not limitation thereof.

FIG. 1 illustrates an example wireless communications system, according to aspects of the disclosure.

FIGS. 2A, 2B, and 2C illustrate example wireless network structures, according to aspects of the disclosure.

FIGS. 3A, 3B, and 3C are simplified block diagrams of several sample aspects of components that may be employed in a user equipment (UE), a base station, and a network entity, respectively, and configured to support communications as taught herein.

FIGS. 4A and 4B illustrate different types of wireless sensing, according to aspects of the disclosure.

FIG. 5 illustrates an example call flow for a New Radio (NR)-based sensing procedure in which the network configures the sensing parameters, according to aspects of the disclosure.

FIG. 6A through 6D illustrate various radio wave propagation scenarios, according to aspects of the disclosure.

FIG. 7 shows an example of operations that may be used in multipath reporting including radio propagation paths information, according to aspects of the disclosure.

FIG. 8 shows a target object sensing scenario that includes reflections traveling along a line-of-sight (LOS) paths and non-line-of-sight (NLOS) paths, according to aspects of the disclosure.

FIG. 9 is a graph illustrating an example of the relative amplitude and reception times for reference signals propagated along the various signal paths shown in FIG. 8.

FIG. 10 illustrates an example method of wireless communication performed by a sensing node, according to aspects of the disclosure.

FIG. 11 illustrates an example method of wireless communication performed by a sensing entity, according to aspects of the disclosure.

FIG. 12 illustrates an example method of wireless communication performed by a sensing node, according to aspects of the disclosure.

### DETAILED DESCRIPTION

Aspects of the disclosure are provided in the following description and related drawings directed to various examples provided for illustration purposes. Alternate aspects may be devised without departing from the scope of the disclosure. Additionally, well-known elements of the disclosure will not be described in detail or will be omitted so as not to obscure the relevant details of the disclosure.

Various aspects relate generally to wireless environment sensing scenarios. Some aspects more specifically relate to the reporting of radio propagation paths information associated with various radio propagation paths in the wireless sensing environment. In some examples, the reported radio propagation paths information and measurements may be used to construct a model (e.g., a digital twin or other model type) of the wireless sensing environment. In some examples, by constructing a model of the wireless sensing environment, the sensing entity may configure the sensing nodes in the wireless sensing environment to provide more accurate measurements of the reference signals measured by the sensing nodes.

Some aspects more specifically relate to the reporting of the characterization of the target paths over which reflections from a target object are propagated. In some examples, the reported characterizations may indicate a likelihood that a given target path is a line-of-sight (LOS) target path or non-line-of-sight (NLOS) target path. By characterizing target paths in this manner, a more accurate determination of the location of the target object may be obtained compared to conventional target object positioning methods.

The words “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

Those of skill in the art will appreciate that the information and signals described below may be represented using any of a variety of different technologies and techniques. For example, data, instructions, commands, information, signals, bits, symbols, and chips that may be referenced throughout the description below may be represented by voltages, currents, electromagnetic waves, magnetic fields or particles, optical fields or particles, or any combination thereof, depending in part on the particular application, in part on the desired design, in part on the corresponding technology, etc.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, the sequence(s) of actions described herein can be considered to be embodied entirely within any form of non-transitory computer-readable storage medium having stored therein a corresponding set of computer instructions that, upon execution, would cause or instruct an associated processor of a device to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

As used herein, the terms “user equipment” (UE) and “base station” are not intended to be specific or otherwise limited to any particular radio access technology (RAT), unless otherwise noted. In general, a UE may be any wireless communication device (e.g., a mobile phone, router, tablet computer, laptop computer, consumer asset locating device, wearable (e.g., smartwatch, glasses, augmented reality (AR)/virtual reality (VR) headset, etc.), vehicle (e.g., automobile, motorcycle, bicycle, etc.), Internet of Things (IoT) device, etc.) used by a user to communicate over a wireless communications network. A UE may be mobile or may (e.g., at certain times) be stationary, and may communicate with a radio access network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or “UT,” a “mobile device,” a “mobile terminal,” a “mobile station,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, wireless local area network (WLAN) networks (e.g., based on the Institute of Electrical and Electronics Engineers (IEEE) 802.11 specification, etc.) and so on.

A base station may operate according to one of several RATs in communication with UEs depending on the network in which it is deployed, and may be alternatively referred to as an access point (AP), a network node, a NodeB, an evolved NodeB (eNB), a next generation eNB (ng-eNB), a New Radio (NR) Node B (also referred to as a gNB or gNodeB), etc. A base station may be used primarily to support wireless access by UEs, including supporting data, voice, and/or signaling connections for the supported UEs. In some systems a base station may provide purely edge node signaling functions while in other systems it may provide additional control and/or network management functions. A communication link through which UEs can send signals to a base station is called an uplink (UL) channel (e.g., a reverse traffic channel, a reverse control channel, an access channel, etc.). A communication link through which the base station can send signals to UEs is called a downlink (DL) or forward link channel (e.g., a paging channel, a control channel, a broadcast channel, a forward traffic channel, etc.). As used herein the term traffic channel (TCH) can refer to either an uplink/reverse or downlink/forward traffic channel.

The term “base station” may refer to a single physical transmission-reception point (TRP) or to multiple physical TRPs that may or may not be co-located. For example, where the term “base station” refers to a single physical TRP, the physical TRP may be an antenna of the base station corresponding to a cell (or several cell sectors) of the base station. Where the term “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (a network of spatially separated antennas connected to a common source via a transport medium) or a remote radio head (RRH) (a remote base station connected to a serving base station). Alternatively, the non-co-located physical TRPs may be the serving base station receiving the measurement report from the UE and a neighbor base station whose reference radio frequency (RF) signals the UE is measuring. Because a TRP is the point from which a base station transmits and receives wireless signals, as used herein, references to transmission from or reception at a base station are to be understood as referring to a particular TRP of the base station.

In some implementations that support positioning of UEs, a base station may not support wireless access by UEs (e.g., may not support data, voice, and/or signaling connections for UEs), but may instead transmit reference signals to UEs to be measured by the UEs, and/or may receive and measure signals transmitted by the UEs. Such a base station may be referred to as a positioning beacon (e.g., when transmitting signals to UEs) and/or as a location measurement unit (e.g., when receiving and measuring signals from UEs).

An “RF signal” comprises an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal.

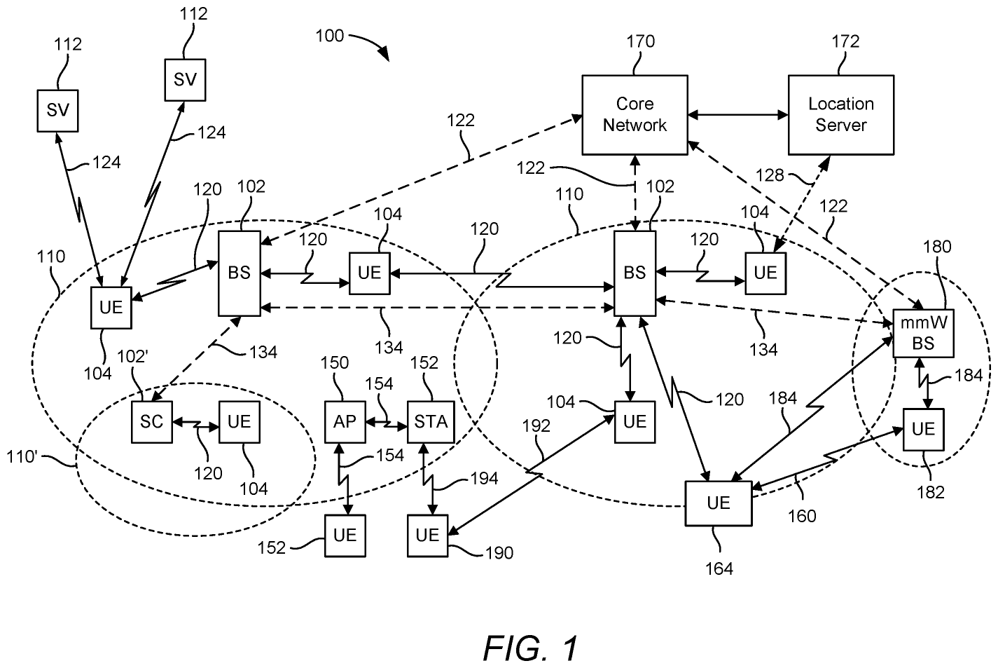

FIG. 1 illustrates an example wireless communications system 100, according to aspects of the disclosure. The wireless communications system 100 (which may also be referred to as a wireless wide area network (WWAN)) may include various base stations 102 (labeled “BS”) and various UEs 104. The base stations 102 may include macro cell base stations (high power cellular base stations) and/or small cell base stations (low power cellular base stations). In an aspect, the macro cell base stations may include eNBs and/or ng-eNBs where the wireless communications system 100 corresponds to an LTE network, or gNBs where the wireless communications system 100 corresponds to a NR network, or a combination of both, and the small cell base stations may include femtocells, picocells, microcells, etc.

The base stations 102 may collectively form a RAN and interface with a core network 170 (e.g., an evolved packet core (EPC) or a 5G core (5GC)) through backhaul links 122, and through the core network 170 to one or more location servers 172 (e.g., a location management function (LMF) or a secure user plane location (SUPL) location platform (SLP)). The location server(s) 172 may be part of core network 170 or may be external to core network 170. A location server 172 may be integrated with a base station 102. A UE 104 may communicate with a location server 172 directly or indirectly. For example, a UE 104 may communicate with a location server 172 via the base station 102 that is currently serving that UE 104. A UE 104 may also communicate with a location server 172 through another path, such as via an application server (not shown), via another network, such as via a wireless local area network (WLAN) access point (AP) (e.g., AP 150 described below), and so on. For signaling purposes, communication between a UE 104 and a location server 172 may be represented as an indirect connection (e.g., through the core network 170, etc.) or a direct connection (e.g., as shown via direct connection 128), with the intervening nodes (if any) omitted from a signaling diagram for clarity.

In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC/5GC) over backhaul links 134, which may be wired or wireless.

The base stations 102 may wirelessly communicate with the UEs 104. Each of the base stations 102 may provide communication coverage for a respective geographic coverage area 110. In an aspect, one or more cells may be supported by a base station 102 in each geographic coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCI), an enhanced cell identifier (ECI), a virtual cell identifier (VCI), a cell global identifier (CGI), etc.) for distinguishing cells operating via the same or a different carrier frequency. In some cases, different cells may be configured according to different protocol types (e.g., machine-type communication (MTC), narrowband IoT (NB-IoT), enhanced mobile broadband (eMBB), or others) that may provide access for different types of UEs. Because a cell is supported by a specific base station, the term “cell” may refer to either or both of the logical communication entity and the base station that supports it, depending on the context. In addition, because a TRP is typically the physical transmission point of a cell, the terms “cell” and “TRP” may be used interchangeably. In some cases, the term “cell” may also refer to a geographic coverage area of a base station (e.g., a sector), insofar as a carrier frequency can be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell base station 102′ (labeled “SC” for “small cell”) may have a geographic coverage area 110′ that substantially overlaps with the geographic coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 between the base stations 102 and the UEs 104 may include uplink (also referred to as reverse link) transmissions from a UE 104 to a base station 102 and/or downlink (DL) (also referred to as forward link) transmissions from a base station 102 to a UE 104. The communication links 120 may use MIMO antenna technology, including spatial multiplexing, beamforming, and/or transmit diversity. The communication links 120 may be through one or more carrier frequencies. Allocation of carriers may be asymmetric with respect to downlink and uplink (e.g., more or less carriers may be allocated for downlink than for uplink).

The wireless communications system 100 may further include a wireless local area network (WLAN) access point (AP) 150 in communication with WLAN stations (STAs) 152 via communication links 154 in an unlicensed frequency spectrum (e.g., 5 GHz). When communicating in an unlicensed frequency spectrum, the WLAN STAs 152 and/or the WLAN AP 150 may perform a clear channel assessment (CCA) or listen before talk (LBT) procedure prior to communicating in order to determine whether the channel is available.

The small cell base station 102′ may operate in a licensed and/or an unlicensed frequency spectrum. When operating in an unlicensed frequency spectrum, the small cell base station 102′ may employ LTE or NR technology and use the same 5 GHz unlicensed frequency spectrum as used by the WLAN AP 150. The small cell base station 102′, employing LTE/5G in an unlicensed frequency spectrum, may boost coverage to and/or increase capacity of the access network. NR in unlicensed spectrum may be referred to as NR-U. LTE in an unlicensed spectrum may be referred to as LTE-U, licensed assisted access (LAA), or MULTEFIRE®.

The wireless communications system 100 may further include a millimeter wave (mmW) base station 180 that may operate in mmW frequencies and/or near mmW frequencies in communication with a UE 182. Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band have high path loss and a relatively short range. The mmW base station 180 and the UE 182 may utilize beamforming (transmit and/or receive) over a mmW communication link 184 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

Transmit beamforming is a technique for focusing an RF signal in a specific direction. Traditionally, when a network node (e.g., a base station) broadcasts an RF signal, it broadcasts the signal in all directions (omni-directionally). With transmit beamforming, the network node determines where a given target device (e.g., a UE) is located (relative to the transmitting network node) and projects a stronger downlink RF signal in that specific direction, thereby providing a faster (in terms of data rate) and stronger RF signal for the receiving device(s). To change the directionality of the RF signal when transmitting, a network node can control the phase and relative amplitude of the RF signal at each of the one or more transmitters that are broadcasting the RF signal. For example, a network node may use an array of antennas (referred to as a “phased array” or an “antenna array”) that creates a beam of RF waves that can be “steered” to point in different directions, without actually moving the antennas. Specifically, the RF current from the transmitter is fed to the individual antennas with the correct phase relationship so that the radio waves from the separate antennas add together to increase the radiation in a desired direction, while cancelling to suppress radiation in undesired directions.

Transmit beams may be quasi-co-located, meaning that they appear to the receiver (e.g., a UE) as having the same parameters, regardless of whether or not the transmitting antennas of the network node themselves are physically co-located. In NR, there are four types of quasi-co-location (QCL) relations. Specifically, a QCL relation of a given type means that certain parameters about a second reference RF signal on a second beam can be derived from information about a source reference RF signal on a source beam. Thus, if the source reference RF signal is QCL Type A, the receiver can use the source reference RF signal to estimate the Doppler shift, Doppler spread, average delay, and delay spread of a second reference RF signal transmitted on the same channel. If the source reference RF signal is QCL Type B, the receiver can use the source reference RF signal to estimate the Doppler shift and Doppler spread of a second reference RF signal transmitted on the same channel. If the source reference RF signal is QCL Type C, the receiver can use the source reference RF signal to estimate the Doppler shift and average delay of a second reference RF signal transmitted on the same channel. If the source reference RF signal is QCL Type D, the receiver can use the source reference RF signal to estimate the spatial receive parameter of a second reference RF signal transmitted on the same channel.

In receive beamforming, the receiver uses a receive beam to amplify RF signals detected on a given channel. For example, the receiver can increase the gain setting and/or adjust the phase setting of an array of antennas in a particular direction to amplify (e.g., to increase the gain level of) the RF signals received from that direction. Thus, when a receiver is said to beamform in a certain direction, it means the beam gain in that direction is high relative to the beam gain along other directions, or the beam gain in that direction is the highest compared to the beam gain in that direction of all other receive beams available to the receiver. This results in a stronger received signal strength (e.g., reference signal received power (RSRP), reference signal received quality (RSRQ), signal-to-interference-plus-noise ratio (SINR), etc.) of the RF signals received from that direction.

Transmit and receive beams may be spatially related. A spatial relation means that parameters for a second beam (e.g., a transmit or receive beam) for a second reference signal can be derived from information about a first beam (e.g., a receive beam or a transmit beam) for a first reference signal. For example, a UE may use a particular receive beam to receive a reference downlink reference signal (e.g., synchronization signal block (SSB)) from a base station. The UE can then form a transmit beam for sending an uplink reference signal (e.g., sounding reference signal (SRS)) to that base station based on the parameters of the receive beam.

Note that a “downlink” beam may be either a transmit beam or a receive beam, depending on the entity forming it. For example, if a base station is forming the downlink beam to transmit a reference signal to a UE, the downlink beam is a transmit beam. If the UE is forming the downlink beam, however, it is a receive beam to receive the downlink reference signal. Similarly, an “uplink” beam may be either a transmit beam or a receive beam, depending on the entity forming it. For example, if a base station is forming the uplink beam, it is an uplink receive beam, and if a UE is forming the uplink beam, it is an uplink transmit beam.

The electromagnetic spectrum is often subdivided, based on frequency/wavelength, into various classes, bands, channels, etc. In 5G NR two initial operating bands have been identified as frequency range designations FR1 (410 MHz-7.125 GHZ) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the INTERNATIONAL TELECOMMUNICATION UNION® as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHZ-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHZ, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

In a multi-carrier system, such as 5G, one of the carrier frequencies is referred to as the “primary carrier” or “anchor carrier” or “primary serving cell” or “PCell,” and the remaining carrier frequencies are referred to as “secondary carriers” or “secondary serving cells” or “SCells.” In carrier aggregation, the anchor carrier is the carrier operating on the primary frequency (e.g., FR1) utilized by a UE 104/182 and the cell in which the UE 104/182 either performs the initial radio resource control (RRC) connection establishment procedure or initiates the RRC connection re-establishment procedure. The primary carrier carries all common and UE-specific control channels, and may be a carrier in a licensed frequency (however, this is not always the case). A secondary carrier is a carrier operating on a second frequency (e.g., FR2) that may be configured once the RRC connection is established between the UE 104 and the anchor carrier and that may be used to provide additional radio resources. In some cases, the secondary carrier may be a carrier in an unlicensed frequency. The secondary carrier may contain only necessary signaling information and signals, for example, those that are UE-specific may not be present in the secondary carrier, since both primary uplink and downlink carriers are typically UE-specific. This means that different UEs 104/182 in a cell may have different downlink primary carriers. The same is true for the uplink primary carriers. The network is able to change the primary carrier of any UE 104/182 at any time. This is done, for example, to balance the load on different carriers. Because a “serving cell” (whether a PCell or an SCell) corresponds to a carrier frequency/component carrier over which some base station is communicating, the term “cell,” “serving cell,” “component carrier,” “carrier frequency,” and the like can be used interchangeably.

For example, still referring to FIG. 1, one of the frequencies utilized by the macro cell base stations 102 may be an anchor carrier (or “PCell”) and other frequencies utilized by the macro cell base stations 102 and/or the mmW base station 180 may be secondary carriers (“SCells”). The simultaneous transmission and/or reception of multiple carriers enables the UE 104/182 to significantly increase its data transmission and/or reception rates. For example, two 20 MHz aggregated carriers in a multi-carrier system would theoretically lead to a two-fold increase in data rate (i.e., 40 MHz), compared to that attained by a single 20 MHz carrier.

The wireless communications system 100 may further include a UE 164 that may communicate with a macro cell base station 102 over a communication link 120 and/or the mmW base station 180 over a mmW communication link 184. For example, the macro cell base station 102 may support a PCell and one or more SCells for the UE 164 and the mmW base station 180 may support one or more SCells for the UE 164.

In some cases, the UE 164 and the UE 182 may be capable of sidelink communication. Sidelink-capable UEs (SL-UEs) may communicate with base stations 102 over communication links 120 using the Uu interface (i.e., the air interface between a UE and a base station). SL-UEs (e.g., UE 164, UE 182) may also communicate directly with each other over a wireless sidelink 160 using the PC5 interface (i.e., the air interface between sidelink-capable UEs). A wireless sidelink (or just “sidelink”) is an adaptation of the core cellular (e.g., LTE, NR) standard that allows direct communication between two or more UEs without the communication needing to go through a base station. Sidelink communication may be unicast or multicast, and may be used for device-to-device (D2D) media-sharing, vehicle-to-vehicle (V2V) communication, vehicle-to-everything (V2X) communication (e.g., cellular V2X (cV2X) communication, enhanced V2X (eV2X) communication, etc.), emergency rescue applications, etc. One or more of a group of SL-UEs utilizing sidelink communications may be within the geographic coverage area 110 of a base station 102. Other SL-UEs in such a group may be outside the geographic coverage area 110 of a base station 102 or be otherwise unable to receive transmissions from a base station 102. In some cases, groups of SL-UEs communicating via sidelink communications may utilize a one-to-many (1:M) system in which each SL-UE transmits to every other SL-UE in the group. In some cases, a base station 102 facilitates the scheduling of resources for sidelink communications. In other cases, sidelink communications are carried out between SL-UEs without the involvement of a base station 102.

In an aspect, the sidelink 160 may operate over a wireless communication medium of interest, which may be shared with other wireless communications between other vehicles and/or infrastructure access points, as well as other RATs. A “medium” may be composed of one or more time, frequency, and/or space communication resources (e.g., encompassing one or more channels across one or more carriers) associated with wireless communication between one or more transmitter/receiver pairs. In an aspect, the medium of interest may correspond to at least a portion of an unlicensed frequency band shared among various RATs. Although different licensed frequency bands have been reserved for certain communication systems (e.g., by a government entity such as the Federal Communications Commission (FCC) in the United States), these systems, in particular those employing small cell access points, have recently extended operation into unlicensed frequency bands such as the Unlicensed National Information Infrastructure (U-NII) band used by wireless local area network (WLAN) technologies, most notably IEEE 802.11x WLAN technologies generally referred to as “Wi-Fi.” Example systems of this type include different variants of CDMA systems, TDMA systems, FDMA systems, orthogonal FDMA (OFDMA) systems, single-carrier FDMA (SC-FDMA) systems, and so on.

Note that although FIG. 1 only illustrates two of the UEs as SL-UEs (i.e., UEs 164 and 182), any of the illustrated UEs may be SL-UEs. Further, although only UE 182 was described as being capable of beamforming, any of the illustrated UEs, including UE 164, may be capable of beamforming. Where SL-UEs are capable of beamforming, they may beamform towards each other (i.e., towards other SL-UEs), towards other UEs (e.g., UEs 104), towards base stations (e.g., base stations 102, 180, small cell 102′, access point 150), etc. Thus, in some cases, UEs 164 and 182 may utilize beamforming over sidelink 160.

In the example of FIG. 1, any of the illustrated UEs (shown in FIG. 1 as a single UE 104 for simplicity) may receive signals 124 from one or more Earth orbiting space vehicles (SVs) 112 (e.g., satellites). In an aspect, the SVs 112 may be part of a satellite positioning system that a UE 104 can use as an independent source of location information. A satellite positioning system typically includes a system of transmitters (e.g., SVs 112) positioned to enable receivers (e.g., UEs 104) to determine their location on or above the Earth based, at least in part, on positioning signals (e.g., signals 124) received from the transmitters. Such a transmitter typically transmits a signal marked with a repeating pseudo-random noise (PN) code of a set number of chips. While typically located in SVs 112, transmitters may sometimes be located on ground-based control stations, base stations 102, and/or other UEs 104. A UE 104 may include one or more dedicated receivers specifically designed to receive signals 124 for deriving geo location information from the SVs 112.

In a satellite positioning system, the use of signals 124 can be augmented by various satellite-based augmentation systems (SBAS) that may be associated with or otherwise enabled for use with one or more global and/or regional navigation satellite systems. For example an SBAS may include an augmentation system(s) that provides integrity information, differential corrections, etc., such as the Wide Area Augmentation System (WAAS), the European Geostationary Navigation Overlay Service (EGNOS), the Multi-functional Satellite Augmentation System (MSAS), the Global Positioning System (GPS) Aided Geo Augmented Navigation or GPS and Geo Augmented Navigation system (GAGAN), and/or the like. Thus, as used herein, a satellite positioning system may include any combination of one or more global and/or regional navigation satellites associated with such one or more satellite positioning systems.

In an aspect, SVs 112 may additionally or alternatively be part of one or more non-terrestrial networks (NTNs). In an NTN, an SV 112 is connected to an earth station (also referred to as a ground station, NTN gateway, or gateway), which in turn is connected to an element in a 5G network, such as a modified base station 102 (without a terrestrial antenna) or a network node in a 5GC. This element would in turn provide access to other elements in the 5G network and ultimately to entities external to the 5G network, such as Internet web servers and other user devices. In that way, a UE 104 may receive communication signals (e.g., signals 124) from an SV 112 instead of, or in addition to, communication signals from a terrestrial base station 102.

The wireless communications system 100 may further include one or more UEs, such as UE 190, that connects indirectly to one or more communication networks via one or more device-to-device (D2D) peer-to-peer (P2P) links (referred to as “sidelinks”). In the example of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (through which UE 190 may indirectly obtain WLAN-based Internet connectivity). In an example, the D2D P2P links 192 and 194 may be supported with any well-known D2D RAT, such as LTE Direct (LTE-D), WI-FI DIRECT®, BLUETOOTH®, and so on.

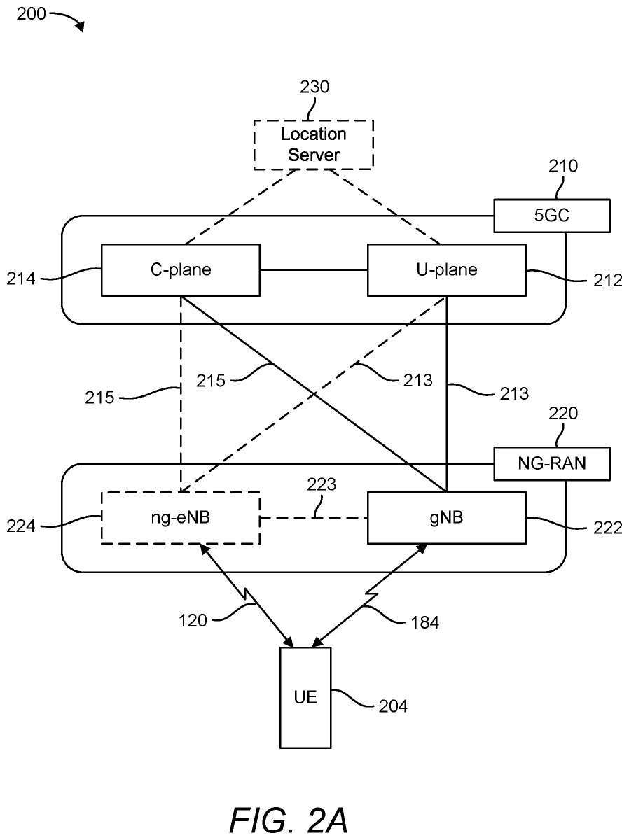

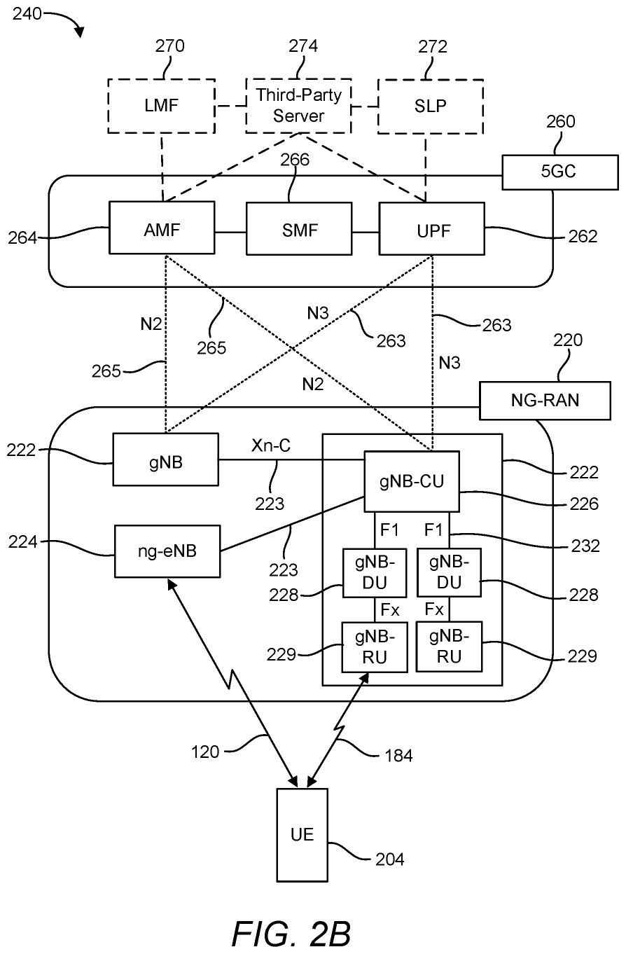

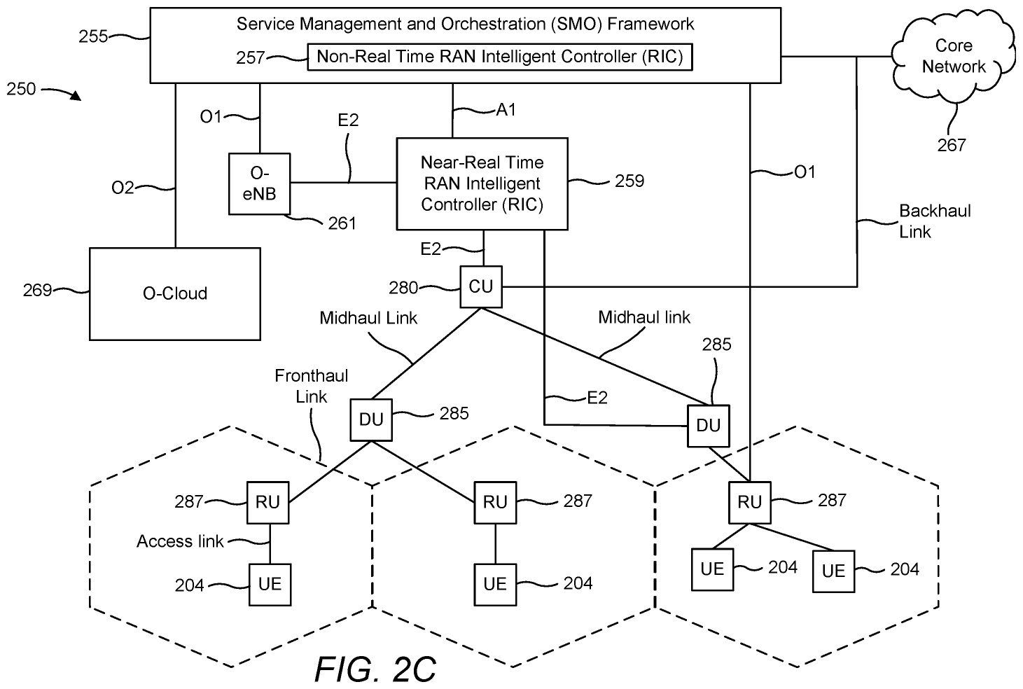

FIG. 2A illustrates an example wireless network structure 200. For example, a 5GC 210 (also referred to as a Next Generation Core (NGC)) can be viewed functionally as control plane (C-plane) functions 214 (e.g., UE registration, authentication, network access, gateway selection, etc.) and user plane (U-plane) functions 212, (e.g., UE gateway function, access to data networks, IP routing, etc.) which operate cooperatively to form the core network. User plane interface (NG-U) 213 and control plane interface (NG-C) 215 connect the gNB 222 to the 5GC 210 and specifically to the user plane functions 212 and control plane functions 214, respectively. In an additional configuration, an ng-eNB 224 may also be connected to the 5GC 210 via NG-C 215 to the control plane functions 214 and NG-U 213 to user plane functions 212. Further, ng-eNB 224 may directly communicate with gNB 222 via a backhaul connection 223. In some configurations, a Next Generation RAN (NG-RAN) 220 may have one or more gNBs 222, while other configurations include one or more of both ng-eNBs 224 and gNBs 222. Either (or both) gNB 222 or ng-eNB 224 may communicate with one or more UEs 204 (e.g., any of the UEs described herein).

Another optional aspect may include a location server 230, which may be in communication with the 5GC 210 to provide location assistance for UE(s) 204. The location server 230 can be implemented as a plurality of separate servers (e.g., physically separate servers, different software modules on a single server, different software modules spread across multiple physical servers, etc.), or alternately may each correspond to a single server. The location server 230 can be configured to support one or more location services for UEs 204 that can connect to the location server 230 via the core network, 5GC 210, and/or via the Internet (not illustrated). Further, the location server 230 may be integrated into a component of the core network, or alternatively may be external to the core network (e.g., a third party server, such as an original equipment manufacturer (OEM) server or service server).

FIG. 2B illustrates another example wireless network structure 240. A 5GC 260 (which may correspond to 5GC 210 in FIG. 2A) can be viewed functionally as control plane functions, provided by an access and mobility management function (AMF) 264, and user plane functions, provided by a user plane function (UPF) 262, which operate cooperatively to form the core network (i.e., 5GC 260). The functions of the AMF 264 include registration management, connection management, reachability management, mobility management, lawful interception, transport for session management (SM) messages between one or more UEs 204 (e.g., any of the UEs described herein) and a session management function (SMF) 266, transparent proxy services for routing SM messages, access authentication and access authorization, transport for short message service (SMS) messages between the UE 204 and the short message service function (SMSF) (not shown), and security anchor functionality (SEAF). The AMF 264 also interacts with an authentication server function (AUSF) (not shown) and the UE 204, and receives the intermediate key that was established as a result of the UE 204 authentication process. In the case of authentication based on a UMTS (universal mobile telecommunications system) subscriber identity module (USIM), the AMF 264 retrieves the security material from the AUSF. The functions of the AMF 264 also include security context management (SCM). The SCM receives a key from the SEAF that it uses to derive access-network specific keys. The functionality of the AMF 264 also includes location services management for regulatory services, transport for location services messages between the UE 204 and a location management function (LMF) 270 (which acts as a location server 230), transport for location services messages between the NG-RAN 220 and the LMF 270, evolved packet system (EPS) bearer identifier allocation for interworking with the EPS, and UE 204 mobility event notification. In addition, the AMF 264 also supports functionalities for non-3GPP® (Third Generation Partnership Project) access networks.

Functions of the UPF 262 include acting as an anchor point for intra/inter-RAT mobility (when applicable), acting as an external protocol data unit (PDU) session point of interconnect to a data network (not shown), providing packet routing and forwarding, packet inspection, user plane policy rule enforcement (e.g., gating, redirection, traffic steering), lawful interception (user plane collection), traffic usage reporting, quality of service (QOS) handling for the user plane (e.g., uplink/downlink rate enforcement, reflective QoS marking in the downlink), uplink traffic verification (service data flow (SDF) to QoS flow mapping), transport level packet marking in the uplink and downlink, downlink packet buffering and downlink data notification triggering, and sending and forwarding of one or more “end markers” to the source RAN node. The UPF 262 may also support transfer of location services messages over a user plane between the UE 204 and a location server, such as an SLP 272.

The functions of the SMF 266 include session management, UE Internet protocol (IP) address allocation and management, selection and control of user plane functions, configuration of traffic steering at the UPF 262 to route traffic to the proper destination, control of part of policy enforcement and QoS, and downlink data notification. The interface over which the SMF 266 communicates with the AMF 264 is referred to as the N11 interface.

Another optional aspect may include an LMF 270, which may be in communication with the 5GC 260 to provide location assistance for UEs 204. The LMF 270 can be implemented as a plurality of separate servers (e.g., physically separate servers, different software modules on a single server, different software modules spread across multiple physical servers, etc.), or alternately may each correspond to a single server. The LMF 270 can be configured to support one or more location services for UEs 204 that can connect to the LMF 270 via the core network, 5GC 260, and/or via the Internet (not illustrated). The SLP 272 may support similar functions to the LMF 270, but whereas the LMF 270 may communicate with the AMF 264, NG-RAN 220, and UEs 204 over a control plane (e.g., using interfaces and protocols intended to convey signaling messages and not voice or data), the SLP 272 may communicate with UEs 204 and external clients (e.g., third-party server 274) over a user plane (e.g., using protocols intended to carry voice and/or data like the transmission control protocol (TCP) and/or IP).

Yet another optional aspect may include a third-party server 274, which may be in communication with the LMF 270, the SLP 272, the 5GC 260 (e.g., via the AMF 264 and/or the UPF 262), the NG-RAN 220, and/or the UE 204 to obtain location information (e.g., a location estimate) for the UE 204. As such, in some cases, the third-party server 274 may be referred to as a location services (LCS) client or an external client. The third-party server 274 can be implemented as a plurality of separate servers (e.g., physically separate servers, different software modules on a single server, different software modules spread across multiple physical servers, etc.), or alternately may each correspond to a single server.

User plane interface 263 and control plane interface 265 connect the 5GC 260, and specifically the UPF 262 and AMF 264, respectively, to one or more gNBs 222 and/or ng-eNBs 224 in the NG-RAN 220. The interface between gNB(s) 222 and/or ng-eNB(s) 224 and the AMF 264 is referred to as the “N2” interface, and the interface between gNB(s) 222 and/or ng-eNB(s) 224 and the UPF 262 is referred to as the “N3” interface. The gNB(s) 222 and/or ng-eNB(s) 224 of the NG-RAN 220 may communicate directly with each other via backhaul connections 223, referred to as the “Xn-C” interface. One or more of gNBs 222 and/or ng-eNBs 224 may communicate with one or more UEs 204 over a wireless interface, referred to as the “Uu” interface.

The functionality of a gNB 222 may be divided between a gNB central unit (gNB-CU) 226, one or more gNB distributed units (gNB-DUs) 228, and one or more gNB radio units (gNB-RUs) 229. A gNB-CU 226 is a logical node that includes the base station functions of transferring user data, mobility control, radio access network sharing, positioning, session management, and the like, except for those functions allocated exclusively to the gNB-DU(s) 228. More specifically, the gNB-CU 226 generally host the radio resource control (RRC), service data adaptation protocol (SDAP), and packet data convergence protocol (PDCP) protocols of the gNB 222. A gNB-DU 228 is a logical node that generally hosts the radio link control (RLC) and medium access control (MAC) layer of the gNB 222. Its operation is controlled by the gNB-CU 226. One gNB-DU 228 can support one or more cells, and one cell is supported by only one gNB-DU 228. The interface 232 between the gNB-CU 226 and the one or more gNB-DUs 228 is referred to as the “F1” interface. The physical (PHY) layer functionality of a gNB 222 is generally hosted by one or more standalone gNB-RUs 229 that perform functions such as power amplification and signal transmission/reception. The interface between a gNB-DU 228 and a gNB-RU 229 is referred to as the “Fx” interface. Thus, a UE 204 communicates with the gNB-CU 226 via the RRC, SDAP, and PDCP layers, with a gNB-DU 228 via the RLC and MAC layers, and with a gNB-RU 229 via the PHY layer.

Deployment of communication systems, such as 5G NR systems, may be arranged in multiple manners with various components or constituent parts. In a 5G NR system, or network, a network node, a network entity, a mobility element of a network, a RAN node, a core network node, a network element, or a network equipment, such as a base station, or one or more units (or one or more components) performing base station functionality, may be implemented in an aggregated or disaggregated architecture. For example, a base station (such as a Node B (NB), evolved NB (eNB), NR base station, 5G NB, AP, TRP, cell, etc.) may be implemented as an aggregated base station (also known as a standalone base station or a monolithic base station) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN ALLIANCE®)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

FIG. 2C illustrates an example disaggregated base station architecture 250, according to aspects of the disclosure. The disaggregated base station architecture 250 may include one or more central units (CUs) 280 (e.g., gNB-CU 226) that can communicate directly with a core network 267 (e.g., 5GC 210, 5GC 260) via a backhaul link, or indirectly with the core network 267 through one or more disaggregated base station units (such as a Near-Real Time (Near-RT) RAN Intelligent Controller (RIC) 259 via an E2 link, or a Non-Real Time (Non-RT) RIC 257 associated with a Service Management and Orchestration (SMO) Framework 255, or both). A CU 280 may communicate with one or more DUs 285 (e.g., gNB-DUs 228) via respective midhaul links, such as an F1 interface. The DUs 285 may communicate with one or more radio units (RUs) 287 (e.g., gNB-RUs 229) via respective fronthaul links. The RUs 287 may communicate with respective UEs 204 via one or more radio frequency (RF) access links. In some implementations, the UE 204 may be simultaneously served by multiple RUs 287.

Each of the units, i.e., the CUs 280, the DUs 285, the RUs 287, as well as the Near-RT RICs 259, the Non-RT RICs 257 and the SMO Framework 255, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a RF transceiver), configured to receive or transmit signals, or both, over a wireless transmission medium to one or more of the other units.

In some aspects, the CU 280 may host one or more higher layer control functions. Such control functions can include RRC, PDCP, service data adaptation protocol (SDAP), or the like. Each control function can be implemented with an interface configured to communicate signals with other control functions hosted by the CU 280. The CU 280 may be configured to handle user plane functionality (i.e., Central Unit-User Plane (CU-UP)), control plane functionality (i.e., Central Unit-Control Plane (CU-CP)), or a combination thereof. In some implementations, the CU 280 can be logically split into one or more CU-UP units and one or more CU-CP units. The CU-UP unit can communicate bidirectionally with the CU-CP unit via an interface, such as the E1 interface when implemented in an O-RAN configuration. The CU 280 can be implemented to communicate with the DU 285, as necessary, for network control and signaling.

The DU 285 may correspond to a logical unit that includes one or more base station functions to control the operation of one or more RUs 287. In some aspects, the DU 285 may host one or more of a RLC layer, a MAC layer, and one or more high PHY layers (such as modules for forward error correction (FEC) encoding and decoding, scrambling, modulation and demodulation, or the like) depending, at least in part, on a functional split, such as those defined by the 3rd Generation Partnership Project (3GPP®). In some aspects, the DU 285 may further host one or more low PHY layers. Each layer (or module) can be implemented with an interface configured to communicate signals with other layers (and modules) hosted by the DU 285, or with the control functions hosted by the CU 280.

Lower-layer functionality can be implemented by one or more RUs 287. In some deployments, an RU 287, controlled by a DU 285, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 287 can be implemented to handle over the air (OTA) communication with one or more UEs 204. In some implementations, real-time and non-real-time aspects of control and user plane communication with the RU(s) 287 can be controlled by the corresponding DU 285. In some scenarios, this configuration can enable the DU(s) 285 and the CU 280 to be implemented in a cloud-based RAN architecture, such as a vRAN architecture.

The SMO Framework 255 may be configured to support RAN deployment and provisioning of non-virtualized and virtualized network elements. For non-virtualized network elements, the SMO Framework 255 may be configured to support the deployment of dedicated physical resources for RAN coverage requirements which may be managed via an operations and maintenance interface (such as an O1 interface). For virtualized network elements, the SMO Framework 255 may be configured to interact with a cloud computing platform (such as an open cloud (O-Cloud) 269) to perform network element life cycle management (such as to instantiate virtualized network elements) via a cloud computing platform interface (such as an O2 interface). Such virtualized network elements can include, but are not limited to, CUs 280, DUs 285, RUs 287 and Near-RT RICs 259. In some implementations, the SMO Framework 255 can communicate with a hardware aspect of a 4G RAN, such as an open eNB (O-eNB) 261, via an O1 interface. Additionally, in some implementations, the SMO Framework 255 can communicate directly with one or more RUs 287 via an O1 interface. The SMO Framework 255 also may include a Non-RT RIC 257 configured to support functionality of the SMO Framework 255.

The Non-RT RIC 257 may be configured to include a logical function that enables non-real-time control and optimization of RAN elements and resources, artificial intelligence/machine learning (AI/ML) workflows including model training and updates, or policy-based guidance of applications/features in the Near-RT RIC 259. The Non-RT RIC 257 may be coupled to or communicate with (such as via an A1 interface) the Near-RT RIC 259. The Near-RT RIC 259 may be configured to include a logical function that enables near-real-time control and optimization of RAN elements and resources via data collection and actions over an interface (such as via an E2 interface) connecting one or more CUs 280, one or more DUs 285, or both, as well as an O-eNB, with the Near-RT RIC 259.

In some implementations, to generate AI/ML models to be deployed in the Near-RT RIC 259, the Non-RT RIC 257 may receive parameters or external enrichment information from external servers. Such information may be utilized by the Near-RT RIC 259 and may be received at the SMO Framework 255 or the Non-RT RIC 257 from non-network data sources or from network functions. In some examples, the Non-RT RIC 257 or the Near-RT RIC 259 may be configured to tune RAN behavior or performance. For example, the Non-RT RIC 257 may monitor long-term trends and patterns for performance and employ AI/ML models to perform corrective actions through the SMO Framework 255 (such as reconfiguration via 01) or via creation of RAN management policies (such as A1 policies).

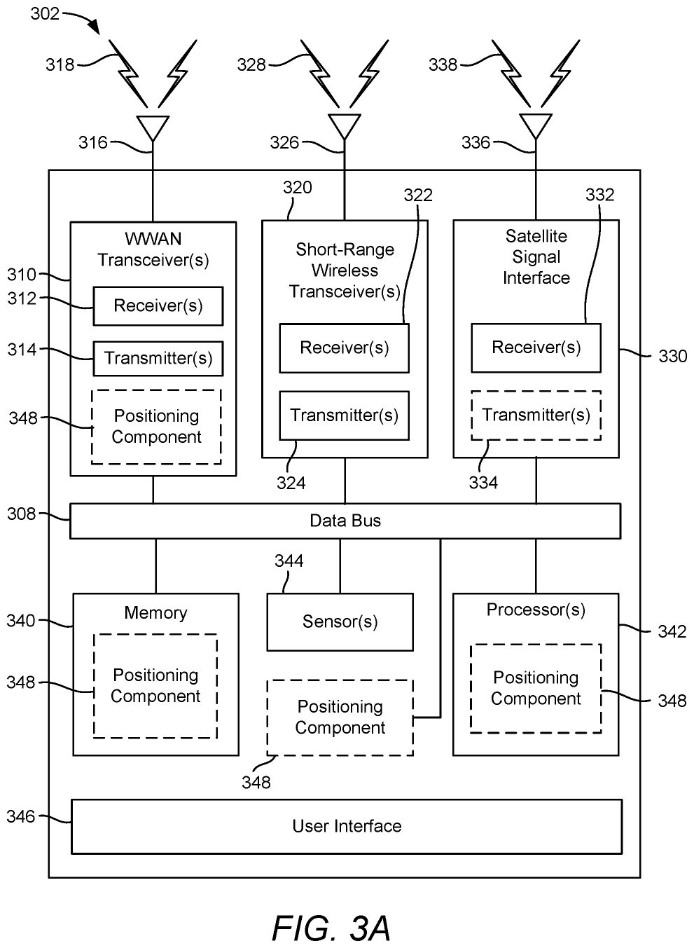

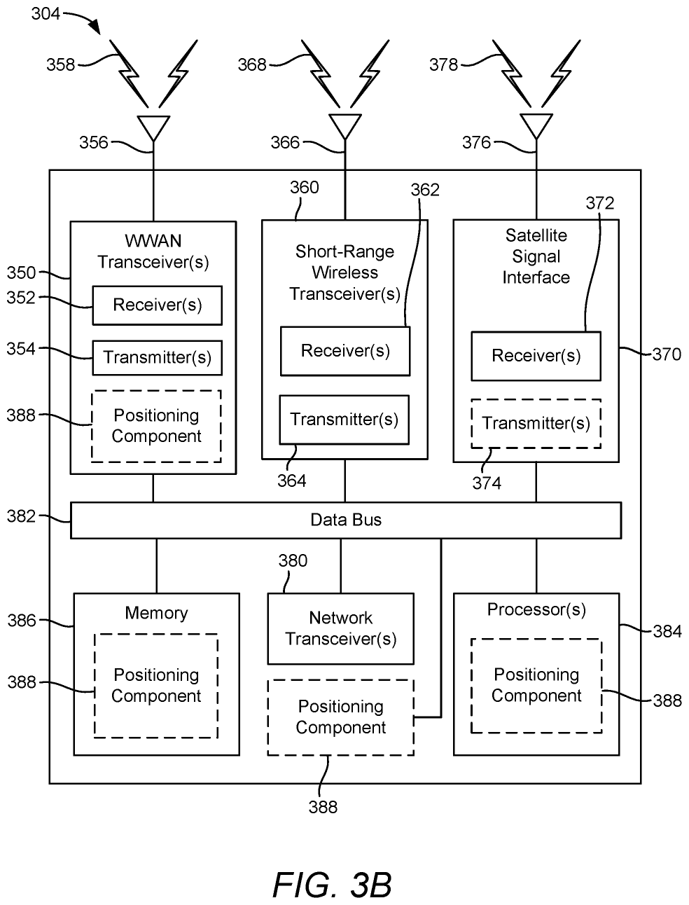

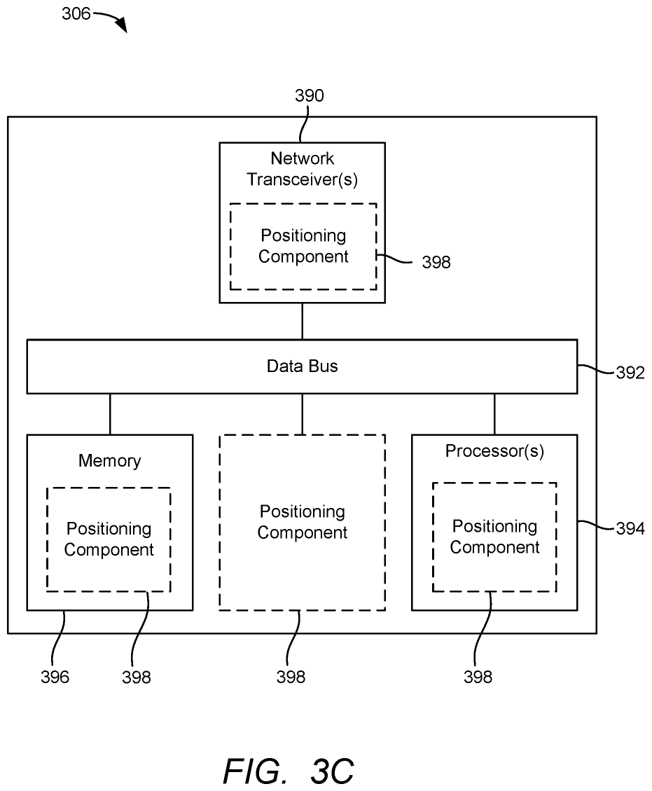

FIGS. 3A, 3B, and 3C illustrate several example components (represented by corresponding blocks) that may be incorporated into a UE 302 (which may correspond to any of the UEs described herein), a base station 304 (which may correspond to any of the base stations described herein), and a network entity 306 (which may correspond to or embody any of the network functions described herein, including the location server 230 and the LMF 270, or alternatively may be independent from the NG-RAN 220 and/or 5GC 210/260 infrastructure depicted in FIGS. 2A and 2B, such as a private network) to support the operations described herein. It will be appreciated that these components may be implemented in different types of apparatuses in different implementations (e.g., in an ASIC, in a system-on-chip (SoC), etc.). The illustrated components may also be incorporated into other apparatuses in a communication system. For example, other apparatuses in a system may include components similar to those described to provide similar functionality. Also, a given apparatus may contain one or more of the components. For example, an apparatus may include multiple transceiver components that enable the apparatus to operate on multiple carriers and/or communicate via different technologies.

The UE 302 and the base station 304 each include one or more wireless wide area network (WWAN) transceivers 310 and 350, respectively, providing means for communicating (e.g., means for transmitting, means for receiving, means for measuring, means for tuning, means for refraining from transmitting, etc.) via one or more wireless communication networks (not shown), such as an NR network, an LTE network, a GSM network, and/or the like. The WWAN transceivers 310 and 350 may each be connected to one or more antennas 316 and 356, respectively, for communicating with other network nodes, such as other UEs, access points, base stations (e.g., eNBs, gNBs), etc., via at least one designated RAT (e.g., NR, LTE, GSM, etc.) over a wireless communication medium of interest (e.g., some set of time/frequency resources in a particular frequency spectrum). The WWAN transceivers 310 and 350 may be variously configured for transmitting and encoding signals 318 and 358 (e.g., messages, indications, information, and so on), respectively, and, conversely, for receiving and decoding signals 318 and 358 (e.g., messages, indications, information, pilots, and so on), respectively, in accordance with the designated RAT. Specifically, the WWAN transceivers 310 and 350 include one or more transmitters 314 and 354, respectively, for transmitting and encoding signals 318 and 358, respectively, and one or more receivers 312 and 352, respectively, for receiving and decoding signals 318 and 358, respectively.

The UE 302 and the base station 304 each also include, at least in some cases, one or more short-range wireless transceivers 320 and 360, respectively. The short-range wireless transceivers 320 and 360 may be connected to one or more antennas 326 and 366, respectively, and provide means for communicating (e.g., means for transmitting, means for receiving, means for measuring, means for tuning, means for refraining from transmitting, etc.) with other network nodes, such as other UEs, access points, base stations, etc., via at least one designated RAT (e.g., Wi-Fi, LTE Direct, BLUETOOTH®, ZIGBEE®, Z-WAVE®, PC5, dedicated short-range communications (DSRC), wireless access for vehicular environments (WAVE), near-field communication (NFC), ultra-wideband (UWB), etc.) over a wireless communication medium of interest. The short-range wireless transceivers 320 and 360 may be variously configured for transmitting and encoding signals 328 and 368 (e.g., messages, indications, information, and so on), respectively, and, conversely, for receiving and decoding signals 328 and 368 (e.g., messages, indications, information, pilots, and so on), respectively, in accordance with the designated RAT. Specifically, the short-range wireless transceivers 320 and 360 include one or more transmitters 324 and 364, respectively, for transmitting and encoding signals 328 and 368, respectively, and one or more receivers 322 and 362, respectively, for receiving and decoding signals 328 and 368, respectively. As specific examples, the short-range wireless transceivers 320 and 360 may be Wi-Fi transceivers, BLUETOOTH® transceivers, ZIGBEE® and/or Z-WAVE® transceivers, NFC transceivers, UWB transceivers, or vehicle-to-vehicle (V2V) and/or vehicle-to-everything (V2X) transceivers.

The UE 302 and the base station 304 also include, at least in some cases, satellite signal interfaces 330 and 370, which each include one or more satellite signal receivers 332 and 372, respectively, and may optionally include one or more satellite signal transmitters 334 and 374, respectively. In some cases, the base station 304 may be a terrestrial base station that may communicate with space vehicles (e.g., space vehicles 112) via the satellite signal interface 370. In other cases, the base station 304 may be a space vehicle (or other non-terrestrial entity) that uses the satellite signal interface 370 to communicate with terrestrial networks and/or other space vehicles.

The satellite signal receivers 332 and 372 may be connected to one or more antennas 336 and 376, respectively, and may provide means for receiving and/or measuring satellite positioning/communication signals 338 and 378, respectively. Where the satellite signal receiver(s) 332 and 372 are satellite positioning system receivers, the satellite positioning/communication signals 338 and 378 may be global positioning system (GPS) signals, global navigation satellite system (GLONASS) signals, Galileo signals, Beidou signals, Indian Regional Navigation Satellite System (NAVIC), Quasi-Zenith Satellite System (QZSS) signals, etc. Where the satellite signal receiver(s) 332 and 372 are non-terrestrial network (NTN) receivers, the satellite positioning/communication signals 338 and 378 may be communication signals (e.g., carrying control and/or user data) originating from a 5G network. The satellite signal receiver(s) 332 and 372 may comprise any suitable hardware and/or software for receiving and processing satellite positioning/communication signals 338 and 378, respectively. The satellite signal receiver(s) 332 and 372 may request information and operations as appropriate from the other systems, and, at least in some cases, perform calculations to determine locations of the UE 302 and the base station 304, respectively, using measurements obtained by any suitable satellite positioning system algorithm.

The optional satellite signal transmitter(s) 334 and 374, when present, may be connected to the one or more antennas 336 and 376, respectively, and may provide means for transmitting satellite positioning/communication signals 338 and 378, respectively. Where the satellite signal transmitter(s) 374 are satellite positioning system transmitters, the satellite positioning/communication signals 378 may be GPS signals, GLONASS® signals, Galileo signals, Beidou signals, NAVIC, QZSS signals, etc. Where the satellite signal transmitter(s) 334 and 374 are NTN transmitters, the satellite positioning/communication signals 338 and 378 may be communication signals (e.g., carrying control and/or user data) originating from a 5G network. The satellite signal transmitter(s) 334 and 374 may comprise any suitable hardware and/or software for transmitting satellite positioning/communication signals 338 and 378, respectively. The satellite signal transmitter(s) 334 and 374 may request information and operations as appropriate from the other systems.

The base station 304 and the network entity 306 each include one or more network transceivers 380 and 390, respectively, providing means for communicating (e.g., means for transmitting, means for receiving, etc.) with other network entities (e.g., other base stations 304, other network entities 306). For example, the base station 304 may employ the one or more network transceivers 380 to communicate with other base stations 304 or network entities 306 over one or more wired or wireless backhaul links. As another example, the network entity 306 may employ the one or more network transceivers 390 to communicate with one or more base station 304 over one or more wired or wireless backhaul links, or with other network entities 306 over one or more wired or wireless core network interfaces.

A transceiver may be configured to communicate over a wired or wireless link. A transceiver (whether a wired transceiver or a wireless transceiver) includes transmitter circuitry (e.g., transmitters 314, 324, 354, 364) and receiver circuitry (e.g., receivers 312, 322, 352, 362). A transceiver may be an integrated device (e.g., embodying transmitter circuitry and receiver circuitry in a single device) in some implementations, may comprise separate transmitter circuitry and separate receiver circuitry in some implementations, or may be embodied in other ways in other implementations. The transmitter circuitry and receiver circuitry of a wired transceiver (e.g., network transceivers 380 and 390 in some implementations) may be coupled to one or more wired network interface ports. Wireless transmitter circuitry (e.g., transmitters 314, 324, 354, 364) may include or be coupled to a plurality of antennas (e.g., antennas 316, 326, 356, 366), such as an antenna array, that permits the respective apparatus (e.g., UE 302, base station 304) to perform transmit “beamforming,” as described herein. Similarly, wireless receiver circuitry (e.g., receivers 312, 322, 352, 362) may include or be coupled to a plurality of antennas (e.g., antennas 316, 326, 356, 366), such as an antenna array, that permits the respective apparatus (e.g., UE 302, base station 304) to perform receive beamforming, as described herein. In an aspect, the transmitter circuitry and receiver circuitry may share the same plurality of antennas (e.g., antennas 316, 326, 356, 366), such that the respective apparatus can only receive or transmit at a given time, not both at the same time. A wireless transceiver (e.g., WWAN transceivers 310 and 350, short-range wireless transceivers 320 and 360) may also include a network listen module (NLM) or the like for performing various measurements.

As used herein, the various wireless transceivers (e.g., transceivers 310, 320, 350, and 360, and network transceivers 380 and 390 in some implementations) and wired transceivers (e.g., network transceivers 380 and 390 in some implementations) may generally be characterized as “a transceiver,” “at least one transceiver,” or “one or more transceivers.” As such, whether a particular transceiver is a wired or wireless transceiver may be inferred from the type of communication performed. For example, backhaul communication between network devices or servers will generally relate to signaling via a wired transceiver, whereas wireless communication between a UE (e.g., UE 302) and a base station (e.g., base station 304) will generally relate to signaling via a wireless transceiver.

The UE 302, the base station 304, and the network entity 306 also include other components that may be used in conjunction with the operations as disclosed herein. The UE 302, the base station 304, and the network entity 306 include one or more processors 342, 384, and 394, respectively, for providing functionality relating to, for example, wireless communication, and for providing other processing functionality. The processors 342, 384, and 394 may therefore provide means for processing, such as means for determining, means for calculating, means for receiving, means for transmitting, means for indicating, etc. In an aspect, the processors 342, 384, and 394 may include, for example, one or more general purpose processors, multi-core processors, central processing units (CPUs), ASICs, digital signal processors (DSPs), field programmable gate arrays (FPGAs), other programmable logic devices or processing circuitry, or various combinations thereof.

The UE 302, the base station 304, and the network entity 306 include memory circuitry implementing memories 340, 386, and 396 (e.g., each including a memory device), respectively, for maintaining information (e.g., information indicative of reserved resources, thresholds, parameters, and so on). The memories 340, 386, and 396 may therefore provide means for storing, means for retrieving, means for maintaining, etc. In some cases, the UE 302, the base station 304, and the network entity 306 may include positioning component 348, 388, and 398, respectively. The positioning component 348, 388, and 398 may be hardware circuits that are part of or coupled to the processors 342, 384, and 394, respectively, that, when executed, cause the UE 302, the base station 304, and the network entity 306 to perform the functionality described herein. In other aspects, the positioning component 348, 388, and 398 may be external to the processors 342, 384, and 394 (e.g., part of a modem processing system, integrated with another processing system, etc.). Alternatively, the positioning component 348, 388, and 398 may be memory modules stored in the memories 340, 386, and 396, respectively, that, when executed by the processors 342, 384, and 394 (or a modem processing system, another processing system, etc.), cause the UE 302, the base station 304, and the network entity 306 to perform the functionality described herein. FIG. 3A illustrates possible locations of the positioning component 348, which may be, for example, part of the one or more WWAN transceivers 310, the memory 340, the one or more processors 342, or any combination thereof, or may be a standalone component. FIG. 3B illustrates possible locations of the positioning component 388, which may be, for example, part of the one or more WWAN transceivers 350, the memory 386, the one or more processors 384, or any combination thereof, or may be a standalone component. FIG. 3C illustrates possible locations of the positioning component 398, which may be, for example, part of the one or more network transceivers 390, the memory 396, the one or more processors 394, or any combination thereof, or may be a standalone component.

The UE 302 may include one or more sensors 344 coupled to the one or more processors 342 to provide means for sensing or detecting movement and/or orientation information that is independent of motion data derived from signals received by the one or more WWAN transceivers 310, the one or more short-range wireless transceivers 320, and/or the satellite signal interface 330. By way of example, the sensor(s) 344 may include an accelerometer (e.g., a micro-electrical mechanical systems (MEMS) device), a gyroscope, a geomagnetic sensor (e.g., a compass), an altimeter (e.g., a barometric pressure altimeter), and/or any other type of movement detection sensor. Moreover, the sensor(s) 344 may include a plurality of different types of devices and combine their outputs in order to provide motion information. For example, the sensor(s) 344 may use a combination of a multi-axis accelerometer and orientation sensors to provide the ability to compute positions in two-dimensional (2D) and/or three-dimensional (3D) coordinate systems.

In addition, the UE 302 includes a user interface 346 providing means for providing indications (e.g., audible and/or visual indications) to a user and/or for receiving user input (e.g., upon user actuation of a sensing device such a keypad, a touch screen, a microphone, and so on). Although not shown, the base station 304 and the network entity 306 may also include user interfaces.

Referring to the one or more processors 384 in more detail, in the downlink, IP packets from the network entity 306 may be provided to the processor 384. The one or more processors 384 may implement functionality for an RRC layer, a packet data convergence protocol (PDCP) layer, a radio link control (RLC) layer, and a medium access control (MAC) layer. The one or more processors 384 may provide RRC layer functionality associated with broadcasting of system information (e.g., master information block (MIB), system information blocks (SIBs)), RRC connection control (e.g., RRC connection paging, RRC connection establishment, RRC connection modification, and RRC connection release), inter-RAT mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer PDUs, error correction through automatic repeat request (ARQ), concatenation, segmentation, and reassembly of RLC service data units (SDUs), re-segmentation of RLC data PDUs, and reordering of RLC data PDUs; and MAC layer functionality associated with mapping between logical channels and transport channels, scheduling information reporting, error correction, priority handling, and logical channel prioritization.

The transmitter 354 and the receiver 352 may implement Layer-1 (L1) functionality associated with various signal processing functions. Layer-1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The transmitter 354 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an orthogonal frequency division multiplexing (OFDM) subcarrier, multiplexed with a reference signal (e.g., pilot) in the time and/or frequency domain, and then combined together using an inverse fast Fourier transform (IFFT) to produce a physical channel carrying a time domain OFDM symbol stream. The OFDM symbol stream is spatially precoded to produce multiple spatial streams. Channel estimates from a channel estimator may be used to determine the coding and modulation scheme, as well as for spatial processing. The channel estimate may be derived from a reference signal and/or channel condition feedback transmitted by the UE 302. Each spatial stream may then be provided to one or more different antennas 356. The transmitter 354 may modulate an RF carrier with a respective spatial stream for transmission.

At the UE 302, the receiver 312 receives a signal through its respective antenna(s) 316. The receiver 312 recovers information modulated onto an RF carrier and provides the information to the one or more processors 342. The transmitter 314 and the receiver 312 implement Layer-1 functionality associated with various signal processing functions. The receiver 312 may perform spatial processing on the information to recover any spatial streams destined for the UE 302. If multiple spatial streams are destined for the UE 302, they may be combined by the receiver 312 into a single OFDM symbol stream. The receiver 312 then converts the OFDM symbol stream from the time-domain to the frequency domain using a fast Fourier transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 304. These soft decisions may be based on channel estimates computed by a channel estimator. The soft decisions are then decoded and de-interleaved to recover the data and control signals that were originally transmitted by the base station 304 on the physical channel. The data and control signals are then provided to the one or more processors 342, which implements Layer-3 (L3) and Layer-2 (L2) functionality.

In the downlink, the one or more processors 342 provides demultiplexing between transport and logical channels, packet reassembly, deciphering, header decompression, and control signal processing to recover IP packets from the core network. The one or more processors 342 are also responsible for error detection.

Similar to the functionality described in connection with the downlink transmission by the base station 304, the one or more processors 342 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through hybrid automatic repeat request (HARQ), priority handling, and logical channel prioritization.

Channel estimates derived by the channel estimator from a reference signal or feedback transmitted by the base station 304 may be used by the transmitter 314 to select the appropriate coding and modulation schemes, and to facilitate spatial processing. The spatial streams generated by the transmitter 314 may be provided to different antenna(s) 316. The transmitter 314 may modulate an RF carrier with a respective spatial stream for transmission.

The uplink transmission is processed at the base station 304 in a manner similar to that described in connection with the receiver function at the UE 302. The receiver 352 receives a signal through its respective antenna(s) 356. The receiver 352 recovers information modulated onto an RF carrier and provides the information to the one or more processors 384.

In the uplink, the one or more processors 384 provides demultiplexing between transport and logical channels, packet reassembly, deciphering, header decompression, control signal processing to recover IP packets from the UE 302. IP packets from the one or more processors 384 may be provided to the core network. The one or more processors 384 are also responsible for error detection.

For convenience, the UE 302, the base station 304, and/or the network entity 306 are shown in FIGS. 3A, 3B, and 3C as including various components that may be configured according to the various examples described herein. It will be appreciated, however, that the illustrated components may have different functionality in different designs. In particular, various components in FIGS. 3A to 3C are optional in alternative configurations and the various aspects include configurations that may vary due to design choice, costs, use of the device, or other considerations. For example, in case of FIG. 3A, a particular implementation of UE 302 may omit the WWAN transceiver(s) 310 (e.g., a wearable device or tablet computer or personal computer (PC) or laptop may have Wi-Fi and/or BLUETOOTH® capability without cellular capability), or may omit the short-range wireless transceiver(s) 320 (e.g., cellular-only, etc.), or may omit the satellite signal interface 330, or may omit the sensor(s) 344, and so on. In another example, in case of FIG. 3B, a particular implementation of the base station 304 may omit the WWAN transceiver(s) 350 (e.g., a Wi-Fi “hotspot” access point without cellular capability), or may omit the short-range wireless transceiver(s) 360 (e.g., cellular-only, etc.), or may omit the satellite signal interface 370, and so on. For brevity, illustration of the various alternative configurations is not provided herein, but would be readily understandable to one skilled in the art.

The various components of the UE 302, the base station 304, and the network entity 306 may be communicatively coupled to each other over data buses 308, 382, and 392, respectively. In an aspect, the data buses 308, 382, and 392 may form, or be part of, a communication interface of the UE 302, the base station 304, and the network entity 306, respectively. For example, where different logical entities are embodied in the same device (e.g., gNB and location server functionality incorporated into the same base station 304), the data buses 308, 382, and 392 may provide communication between them.

The components of FIGS. 3A, 3B, and 3C may be implemented in various ways. In some implementations, the components of FIGS. 3A, 3B, and 3C may be implemented in one or more circuits such as, for example, one or more processors and/or one or more ASICs (which may include one or more processors). Here, each circuit may use and/or incorporate at least one memory component for storing information or executable code used by the circuit to provide this functionality. For example, some or all of the functionality represented by blocks 310 to 346 may be implemented by processor and memory component(s) of the UE 302 (e.g., by execution of appropriate code and/or by appropriate configuration of processor components). Similarly, some or all of the functionality represented by blocks 350 to 388 may be implemented by processor and memory component(s) of the base station 304 (e.g., by execution of appropriate code and/or by appropriate configuration of processor components). Also, some or all of the functionality represented by blocks 390 to 398 may be implemented by processor and memory component(s) of the network entity 306 (e.g., by execution of appropriate code and/or by appropriate configuration of processor components). For simplicity, various operations, acts, and/or functions are described herein as being performed “by a UE,” “by a base station,” “by a network entity,” etc. However, as will be appreciated, such operations, acts, and/or functions may actually be performed by specific components or combinations of components of the UE 302, base station 304, network entity 306, etc., such as the processors 342, 384, 394, the transceivers 310, 320, 350, and 360, the memories 340, 386, and 396, the positioning component 348, 388, and 398, etc.

In some designs, the network entity 306 may be implemented as a core network component. In other designs, the network entity 306 may be distinct from a network operator or operation of the cellular network infrastructure (e.g., NG RAN 220 and/or 5GC 210/260). For example, the network entity 306 may be a component of a private network that may be configured to communicate with the UE 302 via the base station 304 or independently from the base station 304 (e.g., over a non-cellular communication link, such as Wi-Fi).

Wireless communication signals (e.g., radio frequency (RF) signals configured to carry orthogonal frequency division multiplexing (OFDM) symbols in accordance with a wireless communications standard, such as LTE, NR, etc.) transmitted between a UE and a base station can be used for environment sensing (also referred to as “RF sensing” or “radar”). Using wireless communication signals for environment sensing can be regarded as consumer-level radar with advanced detection capabilities that enable, among other things, touchless/device-free interaction with a device/system. The wireless communication signals may be cellular communication signals, such as LTE or NR signals, WLAN signals, such as Wi-Fi signals, etc. As a particular example, the wireless communication signals may be an OFDM waveform as utilized in LTE and NR. High-frequency communication signals, such as millimeter wave (mmW) RF signals, are especially beneficial to use as sensing signals because the higher frequency provides, at least, more accurate range (distance) detection.

Possible use cases of RF sensing include health monitoring use cases, such as heartbeat detection, respiration rate monitoring, and the like, gesture recognition use cases, such as human activity recognition, keystroke detection, sign language recognition, and the like, contextual information acquisition use cases, such as location detection/tracking, direction finding, range estimation, and the like, and automotive sensing use cases, such as smart cruise control, collision avoidance, and the like.

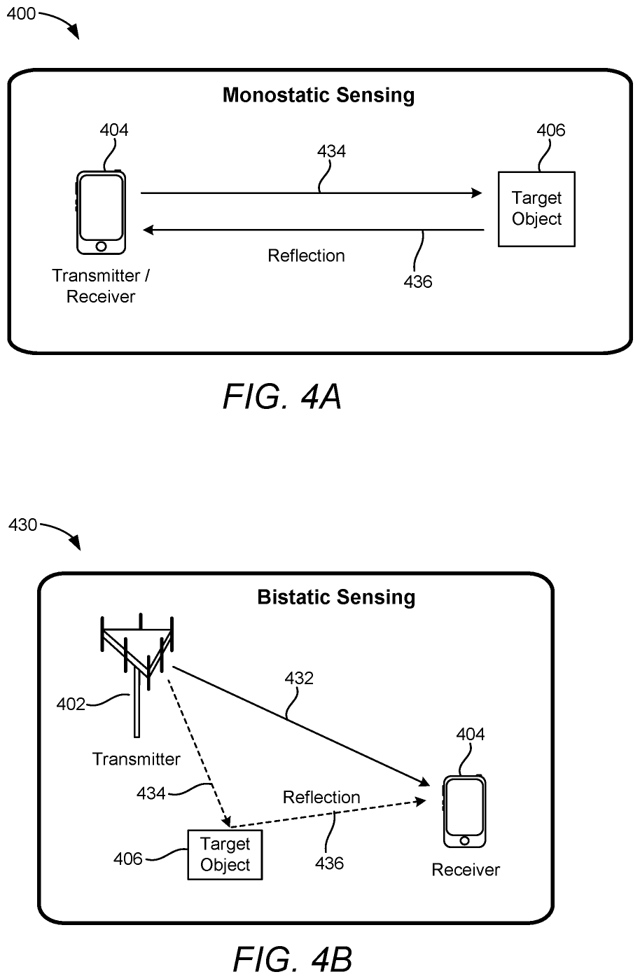

There are different types of sensing, including monostatic sensing (also referred to as “active sensing”) and bistatic sensing (also referred to as “passive sensing”). FIGS. 4A and 4B illustrate these different types of sensing. Specifically, FIG. 4A is a diagram 400 illustrating a monostatic sensing scenario and FIG. 4B is a diagram 430 illustrating a bistatic sensing scenario. In FIG. 4A, the transmitter (Tx) and receiver (Rx) are co-located in the same sensing device 404 (e.g., a UE). The sensing device 404 transmits one or more RF sensing signals 434 (e.g., uplink or sidelink positioning reference signals (PRS) where the sensing device 404 is a UE), and some of the RF sensing signals 434 reflect off a target object 406. The sensing device 404 can measure various properties (e.g., times of arrival (ToAs), angles of arrival (AoAs), phase shift, etc.) of the reflections 436 of the RF sensing signals 434 to determine characteristics of the target object 406 (e.g., size, shape, speed, motion state, etc.).

In FIG. 4B, the transmitter (Tx) and receiver (Rx) are not co-located, that is, they are separate devices (e.g., a UE and a base station). Note that while FIG. 4B illustrates using a downlink RF signal as the RF sensing signal 432, uplink RF signals or sidelink RF signals can also be used as RF sensing signals 432. In a downlink scenario, as shown, the transmitter is a base station and the receiver is a UE, whereas in an uplink scenario, the transmitter is a UE and the receiver is a base station.

Referring to FIG. 4B in greater detail, the transmitter device 402 transmits RF sensing signals 432 and 434 (e.g., positioning reference signals (PRS)) to the sensing device 404, but some of the RF sensing signals 434 reflect off a target object 406. The sensing device 404 (also referred to as the “sensing device”) can measure the times of arrival (ToAs) of the RF sensing signals 432 received directly from the transmitter device and the ToAs of the reflections 436 of the RF sensing signals 434 reflected from the target object 406.

More specifically, as described above, a transmitter device (e.g., a base station) may transmit a single RF signal or multiple RF signals to a sensing device (e.g., a UE). However, the receiver may receive multiple RF signals corresponding to each transmitted RF signal due to the propagation characteristics of RF signals through multipath channels. Each path may be associated with a cluster of one or more channel taps. Generally, the time at which the receiver detects the first cluster of channel taps is considered the ToA of the RF signal on the line-of-site (LOS) path (i.e., the shortest path between the transmitter and the receiver). Later clusters of channel taps are considered to have reflected off objects between the transmitter and the receiver and therefore to have followed non-LOS (NLOS) paths between the transmitter and the receiver.

Thus, referring back to FIG. 4B, the RF sensing signals 432 followed the LOS path between the transmitter device 402 and the sensing device 404, and the RF sensing signals 434 followed an NLOS path between the transmitter device 402 and the sensing device 404 due to reflecting off the target object 406. The transmitter device 402 may have transmitted multiple RF sensing signals 432, 434, some of which followed the LOS path and others of which followed the NLOS path. Alternatively, the transmitter device 402 may have transmitted a single RF sensing signal in a broad enough beam that a portion of the RF sensing signal followed the LOS path (RF sensing signal 432) and a portion of the RF sensing signal followed the NLOS path (RF sensing signal 434).

Based on the ToA of the LOS path, the ToA of the NLOS path, and the speed of light, the sensing device 404 can determine the distance to the target object(s). For example, the sensing device 404 can calculate the distance to the target object as the difference between the ToA of the LOS path and the ToA of the NLOS path multiplied by the speed of light. In addition, if the sensing device 404 is capable of receive beamforming, the sensing device 404 may be able to determine the general direction to a target object as the direction (angle) of the receive beam on which the RF sensing signal following the NLOS path was received. That is, the sensing device 404 may determine the direction to the target object as the angle of arrival (AoA) of the RF sensing signal, which is the angle of the receive beam used to receive the RF sensing signal. The sensing device 404 may then optionally report this information to the transmitter device 402, its serving base station, an application server associated with the core network, an external client, a third-party application, or some other sensing entity. Alternatively, the sensing device 404 may report the ToA measurements to the transmitter device 402, or other sensing entity (e.g., if the sensing device 404 does not have the processing capability to perform the calculations itself), and the transmitter device 402 may determine the distance and, optionally, the direction to the target object 406.

Note that if the RF sensing signals are uplink RF signals transmitted by a UE to a base station, the base station would perform object detection based on the uplink RF signals just like the UE does based on the downlink RF signals.

Like conventional radar, wireless communication-based sensing signals can be used to estimate the range (distance), velocity (Doppler), and angle (AoA) of a target object. However, the performance (e.g., resolution and maximum values of range, velocity, and angle) may depend on the design of the reference signal.

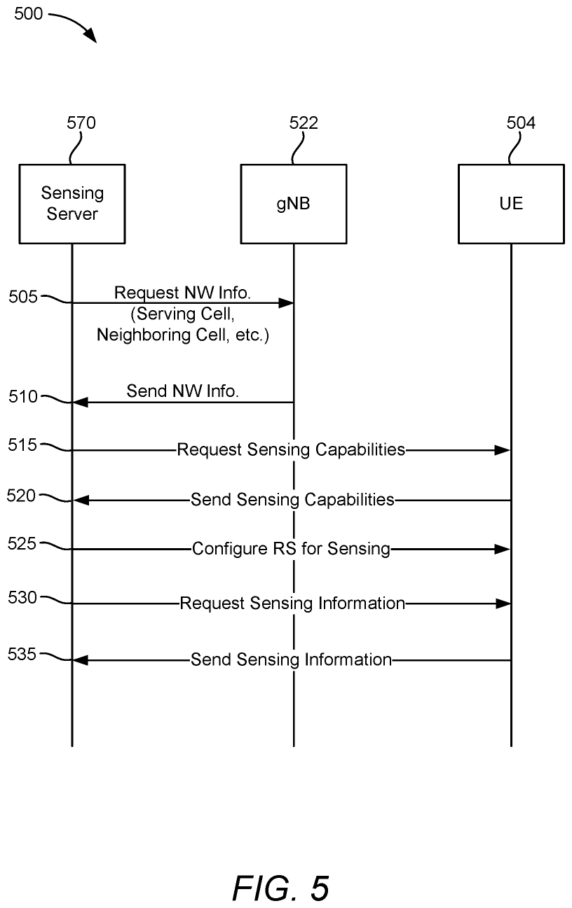

FIG. 5 illustrates an example call flow 500 for an NR-based sensing procedure (e.g., a bistatic sensing procedure) in which the network configures the sensing parameters, according to aspects of the disclosure. Although FIG. 5 illustrates a network-coordinated sensing procedure, the sensing procedure could be coordinated over sidelink channels.

At stage 505, a sensing server 570 (e.g., inside or outside the core network) sends a request for network (NW) information to a gNB 522 (e.g., the serving gNB of a UE 504). The request may be for a list of the UE's 504 serving cell and any neighboring cells. At stage 510, the gNB 522 sends the requested information to the sensing server 570. At stage 515, the sensing server 570 sends a request for sensing capabilities to the UE 504. At stage 520, the UE 504 provides its sensing capabilities to the sensing server 570.

At stage 525, the sensing server 570 sends a configuration to the UE 504 indicating one or more reference signal (RS) resources that will be transmitted for sensing. The reference signal resources may be transmitted by the serving and/or neighboring cells identified at stage 510. In some cases, the NR-based sensing procedure illustrated in FIG. 5 may be a sensing-only procedure or a joint communication and sensing (JCS) procedure. In the case of a sensing-only procedure, the reference signal resources may be reference signal resources specifically configured for sensing purposes. In the case of a JCS procedure, the reference signal resources may be reference signal resources for communication that can also be used for sensing purposes. Alternatively, the reference signal resources for sensing may be multiplexed (e.g., time-division multiplexed) with reference signal resources for communication. For example, the reference signal resources for communication may be an orthogonal frequency division multiplexing (OFDM) waveform, while the reference signal resources for sensing may be a frequency modulation continuous wave (FMCW) waveform.

At stage 530, the sensing server 570 sends a request for sensing information to the UE 504. The UE 504 then measures the transmitted reference signals and, at stage 535, sends the measurements, or any sensing results determined from the measurements, to the sensing server 570.

In an aspect, the communication between the UE 504 and the sensing server 570 may be via the LTE positioning protocol (LPP). The communication between the sensing server 570 and the gNB may be via NR positioning protocol type A (NRPPa).

The sensing scenarios shown in FIG. 4A and FIG. 4B may be extended to scenarios in which the target object 404 in each scenario is an Automated Guided Vehicle (AGV). In the monostatic sensing scenario shown in FIG. 4A, the sensing environment may be configured in a gNB mode in which the sensing device 404 may be a gNB/TRP. In a monostatic UE mode, the sensing device 404 shown in FIG. 4A may be a UE. In the bistatic sensing scenario shown in FIG. 4B

The bistatic sensing scenario shown in FIG. 4B may likewise be extended to different scenarios in which the target object 404 is an AGV. In a bistatic gNB-to-gNB sensing mode, the sensing environment may be configured so that both the transmitter device 402 and the sensing device 404 are gNBs. In a bistatic UE-to-gNB sensing mode, the sensing environment may be configured so that both the transmitter device 402 is a UE and the sensing device 404 is a gNB/TRP. In a bistatic gNB-to-UEsensing mode, the sensing environment may be configured so that the transmitter device more 402 is a gNB/TRP while the sensing device 404 is a UE. In a bistatic UE-to-UE sensing mode, the sensing environment may be configured so that both the transmitter device 402 and the sensing device 404 are UEs.

There are a wide range of Key Performance Indicators (KPI) associated with the target object sensing environments. Such KPI may include: 1) Accuracy of positioning (horizontal/vertical); 2) Accuracy of range and cross-range of target; 3) Accuracy of AoA of a target (azimuth/elevation); 4) Accuracy of velocity (horizontal/vertical); 5) Sensing range/cross-range resolutions; 6) Sensing velocity resolution; 7) Sensing angle resolution; 8) Sensing latency; 9) Sensing refreshing rate; 10) Receiver operating characteristics (ROC) (e.g., misdetection and false alarm probabilities); 11) Confidence interval/level of sensing; and/or 11) Target discrimination.

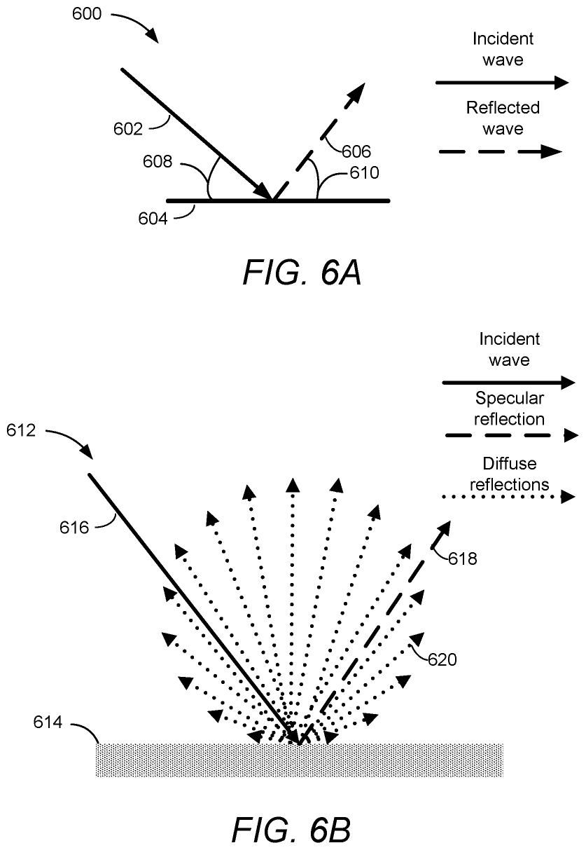

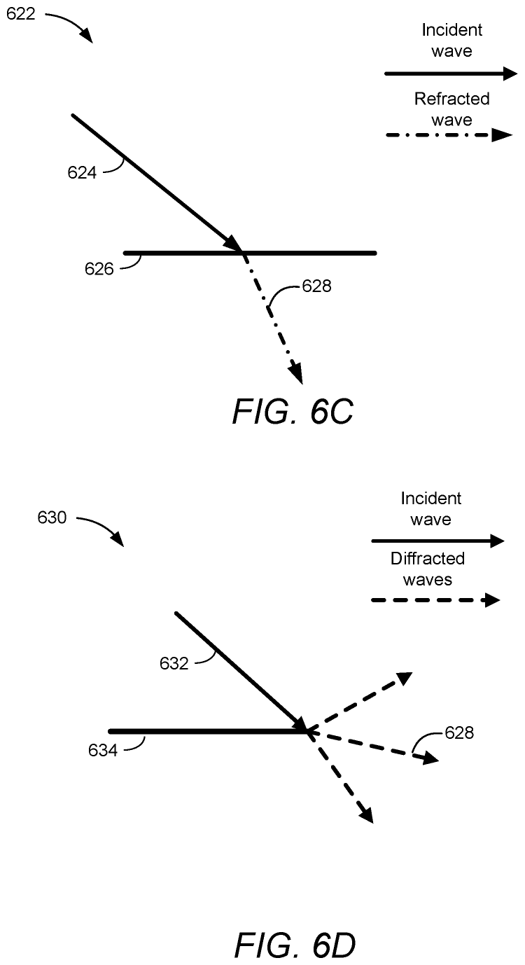

FIG. 6A through 6D illustrate various radio wave propagation scenarios, according to aspects of the disclosure. FIG. 6A shows a reflection scenario 600 in which an incident radio wave 602 impinges on a reflecting surface 604 and is reflected as a reflected wave 606. Reflection refers to the phenomenon where radio waves bounce off a surface. When a radio wave encounters a boundary between two different mediums, such as air and a building or the ground, a part of the wave's energy is reflected back into the original medium.

The amount and angle of reflection depend on several factors such as the surface material of the reflecting surface 604, the angle of incidence, the wavelength of the radio wave, and the polarization of the radio wave. As such, the measurement of the reflected radio wave can be used to determine certain characteristics of the reflecting surface.

With respect to the surface material of the surface 604, different surface materials may have different reflective properties. For example, conductive materials (e.g., metals) are typically highly reflective of radio waves, while non-conductive materials (e.g., wood or plastic) may reflect less energy. The angle of incidence 608 is the angle at which the radio wave 602 hits the surface 604. The law of reflection states that the angle of incidence 608 is equal to the angle of reflection 610.

With respect to the wavelength of the radio wave, the wavelength relative to the size and texture of the reflecting surface 604 also impacts the reflected waves. FIG. 6B shows an example reflection scenario 612 for different surface textures of a reflecting surface 614. For example, smooth surfaces at the scale of the wavelength of the incident radio wave 616 will result in specular reflection 618 of the incident radio wave 616. If the surface texture of the reflecting surface 614 is rough relative to the scale of the wavelength of the incident radio wave 616, the resulting reflective waves are scattered as diffuse reflections 620.

With respect to the polarization of the incident radio wave, a reflecting surface (e.g., reflecting surface 604, reflecting surface 614, etc.) may alter the polarization of the reflected radio wave. In an aspect, the polarization of the reflected radio wave may be different or otherwise altered by the reflecting surface when compared to the polarization of the incident radio wave and dependent on the characteristics of the reflecting surface.

FIG. 6C shows an example refraction scenario 622 in which an incident radio wave 624 meets a refracting medium 626, resulting in a refracted radio wave 628. Refraction refers to the bending or change in the direction of radio waves as they pass through different media with varying refractive indices. In an aspect, refraction may occur when a radio wave travels from one medium to another (e.g., through layers of the atmosphere with different densities and temperatures.) There are several factors affecting the refraction of a radio wave. For example, when a radio wave enters a medium with a different refractive index, its speed changes. Typically, in the atmosphere, as radio waves move into denser layers, they slow down. Due to the change in speed, the path of the radio wave bends from its original path. The direction of bending depends on the gradient of the refractive index. If a wave travels from a less dense to a more dense medium, it bends towards the normal (an imaginary line perpendicular to the surface at the point of incidence).

FIG. 6D shows an example diffraction scenario 630 in which an incident radio wave 632 meets a diffracting obstacle 634, resulting in diffracted radio waves 638. Diffraction is a wave phenomenon that occurs when a radio wave encounters an obstacle or a slit that disrupts its path. Diffraction involves the bending and spreading of waves around the edges of an obstacle or through an aperture. When a radio wave encounters an obstacle, the radio wave bends around the edges of the obstacle. In certain scenarios, this bending allows the radio wave to reach areas that would otherwise be in the shadow of the obstacle if the wave traveled in straight lines only. Further, when a radio wave passes through a narrow opening, the radio wave may spread out or diverge at the other side of the object. The extent of this spreading increases as the size of the aperture decreases relative to the wavelength of the wave. For example, the degree of diffraction of the radio wave depends on the wavelength of the radio wave and the size of the obstacle or aperture. Generally, when the wavelength of the radio wave is comparable to the size of the obstacle or aperture, significant diffraction occurs. In some cases, diffraction can produce patterns of constructive and destructive interference, leading to a detectable distribution of wave intensity.

As shown and described with reference to FIG. 4A and FIG. 4B, in RF sensing, a wireless signal can be transmitted from one or multiple transmit points and received at one or multiple receive points after being reflected off a target. Integrated Sensing and Communication (ISAC) in the context of such wireless sensing is increasingly becoming an important part of wireless systems. Such ISC systems have a wide range of use cases such as intruder detection, animal/pedestrian/UAV intrusion detection in highways and railways, rainfall monitoring, flooding awareness, autonomous driving, Automated Guided Vehicle (AGV) detection/tracking/collision avoidance, smart parking and assistance, Unmanned Aerial Vehicle (UAV) trajectory and tracking, crowd management, sleep/health monitoring, gesture recognition, extended reality straining, public safety search and rescue, etc.

Certain aspects of the disclosure are implemented with a recognition that the generation of a digital twin of a wireless environment can help generate and enable conducting online and/or offline optimization of a wireless system. In an aspect, a digital twin can also help in the generation of wireless data that can enable many data-driven solutions. For example, a digital twin of a wireless environment may be used with Artificial Intelligence (AI) and Machine Learning (ML) techniques for compressing and predicting Channel State Information (CSI) in the actual wireless environment. In an aspect, a digital twin of a wireless environment may be used for beam management, positioning, sensing, etc.

One of the challenges related to constructing a digital twin is how to calibrate the digital twin and ensure that it accurately represents the corresponding wireless environment. While real field measurements (e.g., channel frequency response (CFR), channel impulse response (CIR), power delay profile (PDP), delay profile (DP), Doppler profile (DPP), etc.) can be obtained for calibration purposes, such measurements do not describe how the wireless environment is geometrically structured or how the radio signals interact with the underlying structure and geometry of the wireless environment. In an aspect, these measurements (e.g., CIR) may be enriched by adding additional information that describes how the signal interacted with the environment. For example, the measurements may be enriched by indicating the status of signal/path interactions with objects constituting the environment (e.g., reflection, refraction, diffraction, scattering). However, current multipath reporting is limited and only provides line-of-sight/non-line-of-sight (LOS/NLOS) characteristics of a reported multipath signal.

Certain aspects of the disclosure are implemented with a recognition that physical interactions between an electromagnetic wave (e.g., RF signal) and objects within a wireless environment can be measured and used to characterize and/or model the wireless environment. In an aspect, the measurements may be conducted so that the measurements are associated with an identified radio wave path in the wireless environment. Such measurable interactions may include changes in the power of the electromagnetic wave, changes in the phase of the electromagnetic wave, changes in the polarization of the electromagnetic wave, times of arrival, total time of flight, etc. Such changes may be correlated to wave reflections, wave refractions, wave diffractions, wave scattering, etc., associated with the objects in the wireless environment.

The types of measurable changes associated with such propagation characteristics are discussed above in connection with FIG. 6A through FIG. 6B. In an aspect, whether a wave traveling along a path experienced reflection, refraction, diffraction, and/or scattering may be ascertained by leveraging a combination of assistance data and information (e.g., the geometry of the underlying environment, location of the transmitter and/or receiver, location of objects and their shape/orientation). In an aspect, it may also be possible to apply some signal processing on multipath measurements (e.g., timing, power, and phase) to deduce the occurrence of different radio propagation events (e.g., by looking at the differential/relative phase and power of multipath components).

As noted herein, current multipath reporting associated with a wireless environment is limited. Accordingly, certain aspects of the disclosure are directed to expanding multipath reporting to include radio propagation paths information associated with the radio propagation paths in a wireless environment. In an aspect, a sensing node (e.g., UE, TRP, etc.) obtains multipath measurements of sensing signals associated with radio propagation paths and uses the measurements to obtain radio propagation paths information associated with the radio propagation paths. In turn, the sensing node reports the multipath measurements and the radio propagation paths information associated with the propagation paths to a sensing entity (e.g., network entity, LMF, sensing module function, gNB, etc.).

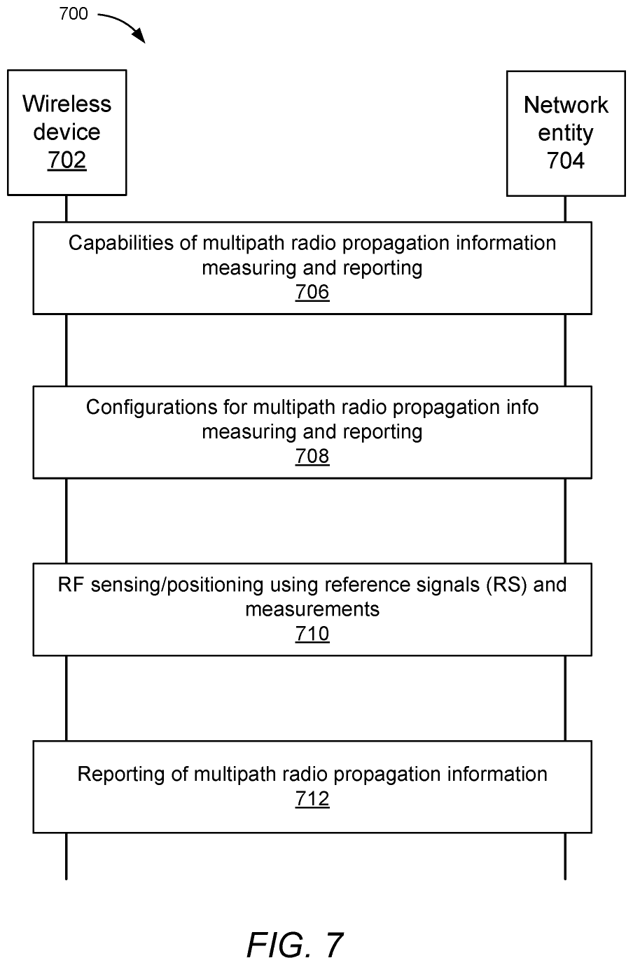

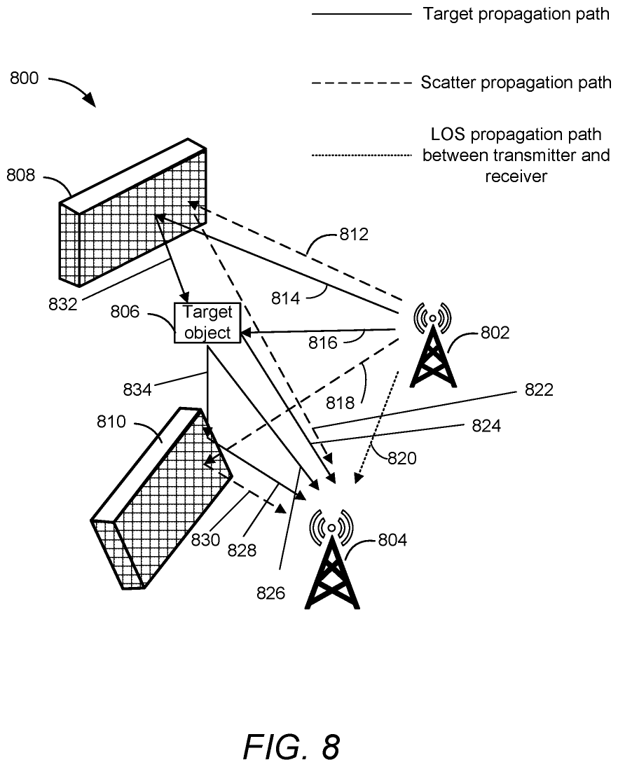

FIG. 7 shows an example of operations 700 that may be used in multipath reporting, including radio propagation paths information, according to aspects of the disclosure. In this example, the exchange of communication occurs between a wireless device 702 and a network entity 704. In an aspect, the wireless device may be a UE and/or TRP, while the network entity may be an LMF, sensing management function (SnMF), and/or a gNB. At operation 706, the network entity 704 and the wireless device 702 may exchange communications in which the wireless device 702 indicates its capabilities for radio propagation and measurement reporting.

The radio propagation reporting capabilities reported to the sensing entity may include: 1) an indication of one or more methods used by the wireless device 702 (e.g., sensing node) for reporting the radio propagation paths information; 2) an indication of radio propagation events used by the wireless device 702 for reporting the radio propagation paths information; 3) an indication of one or more types of information that can be provided by the wireless device 702 for reporting the radio propagation paths information; or 4) any combination thereof.

In an aspect, the reporting capabilities can be signaled as part of the LTE Positioning Protocol (LPP) and/or the New Radio Positioning Protocol A (NRPPa). In an aspect, the reporting capabilities may include a TRP information exchange procedure and/or a UE capability exchange procedure.

Based on this exchange, the network entity 704 may send a reporting configuration to the wireless device 702 at operation 708 indicating the multipath radio propagation paths information the wireless device 702 measures and reports to the network entity 704. At operation 710, the wireless device obtains the multipath radio propagation paths information indicated by the reporting configuration received from the network entity 704. In an aspect, the wireless device 702 may cooperate with other wireless devices, gNBs, and/or TRPs for the measurement operations. At operation 712, the wireless device reports the multipath radio propagation paths information indicated by the reporting configuration received from the network entity 704.

In an aspect, the configuration may be signaled as part of the LPP and/or NRPPa protocols. In an aspect the configuration may be provided in assistance data and/or an info exchange procedure. In an aspect, the configuration may be signaled during a Provide location/sensing information exchange procedure. In an aspect, the configuration may be signaled in a positioning and/or sensing broadcast (e.g., in a Positioning System Information Block (posSIB) and/or Sensing System Information Block (senseSIB)).

Based on the radio propagation measurement and reporting capabilities of the wireless device 702, the multipath radio propagation paths information indicated by the reporting configuration may include various types of radio propagation paths information and/or measurements from which the radio propagation paths information is derived by the wireless device 702. In an aspect, radio propagation measurements may be reported to the network entity 704, which performs the operations used to extract the radio propagation paths information.

Depending on the radio propagation measurement and reporting capabilities of the wireless device 702 indicated in the radio propagation configuration, the wireless device 702 may provide radio propagation paths information, including: 1) reflection information associated with the one or more radio propagation paths; 2) refraction information associated with the one or more radio propagation paths; 3) diffraction information associated with the one or more radio propagation paths; 4) scattering information associated with the one or more radio propagation paths; 5) a sequence of propagation events information associated with the one or more radio propagation paths; 6) quality metric information associated with the one or more radio propagation paths; or 7) any combination thereof.

In an aspect, the reflection information associated with one or more radio propagation paths may include: 1) an indication (e.g., flag) that a given set of reflection information is associated with a given path of the one or more radio propagation paths; 2) an indication of angles of reflections at a reflection point of the one or more radio propagation paths; 3) an indication of a number of reflections (e.g., order of reflection) associated with the one or more radio propagation paths; 4) an indication of a location associated with the one or more radio propagation paths; or 5) any combination thereof.

In an aspect, the refraction information associated with the one or more radio propagation paths may include: 1) an indication that the refraction information is associated with a given radio propagation path of the one or more radio propagation paths; 2) an indication of one or more angles of refraction associated with the given radio propagation path of the one or more radio propagation paths; 3) an indication of a number of refractions (e.g., order of refractions) associated with a given radio propagation path of the one or more radio propagation paths; 4) an indication of a refraction point associated with a given radio propagation path of the one or more radio propagation paths; or 5) any combination thereof.

In an aspect, the diffraction information associated with the one or more radio propagation paths may include: 1) an indication that the diffraction information is associated with a given radio propagation path of the one or more radio propagation paths; 2) an indication of an angle of diffraction associated with the given radio propagation path of the one or more radio propagation paths; 3) an indication of a type of diffraction associated with the given radio propagation path of the one or more radio propagation paths; 4) an indication of a location of one or more diffraction points associated with the given radio propagation path of the one or more radio propagation paths; 5) or any combination thereof.

In an aspect, the scattering information associated with the one or more radio propagation paths may include: 1) an indication that the scattering information is associated with a given radio propagation path of the one or more radio propagation paths; 2) an indication of an angle of scattering associated with a given radio propagation path of the one or more radio propagation paths; 3) an indication of a type of scattering associated with a given radio propagation path of the one or more radio propagation paths; 4) an indication of a number of scatterings associated with a given radio propagation path of the one or more radio propagation paths; 5) an indication of a location of one or more scattering points associated with a given radio propagation path of the one or more radio propagation paths; or 6) any combination thereof.

The radio propagation paths information and/or measurements included by the wireless device 702 in the report may be used by the network entity 704 for various purposes. In an aspect, the network entity may use the reported to model a multipath radio propagation environment based on the multipath measurements and radio propagation paths information associated with the one or more radio propagation paths received in the report. In an aspect, the modeling of the multipath radio propagation environment may include: 1) constructing a digital twin of the multipath radio propagation environment; 2) calibrate an existing digital twin of the multipath radio propagation environment; 3) generate a dataset for training a machine learning model of the multipath radio propagation environment; 4) augment an existing dataset used to train the machine learning model of the multipath radio propagation environment; 5) monitor the performance of the machine learning model of the multipath radio propagation environment; or 6) any combination thereof.

Certain aspects of the disclosure are directed to a target object positioning. Typically, target positioning happens assuming LOS states of the propagation paths of the RS. For a propagation path with an LOS state from the target, assuming the target location is x, and the location of the transmitter and the receiver is P_{Tx} and P_{Rx}, then the following equation is applicable to the positioning determination:

y_{LOS}(Tx,Rx)=(∥P_{Tx}−x∥²+∥P_{Rx}−x∥²)^{1/2}

The foregoing equation is applicable to the target positioning scenarios having multiple transmitter and receiver pairs (Tx, Rx) having LOS propagation paths. To this end, the position of the target can be estimated by solving the corresponding set of equations associated with each transmitter and receiver pair.

The foregoing equation, however, is not valid when the propagation path to the target is not an LOS path. In such scenarios, the measured value y_{NLOS} (Tx, Rx) is greater than the measured value of y_{LOS} (Tx, Rx). As such, the assumption that the propagation paths are all LOS paths fails to provide a satisfactory measurement when many of the propagation paths are NLOS paths. In such instances, assuming that all of the propagation paths are LOS paths can degrade the determination of the position of the target.

Certain aspects of the disclosure are directed to reporting radio propagation paths information indicating whether reflections from a target object are associated with an LOS path or NLOS path. Knowing the LOS/NLOS properties of the propagation paths can be used to determine the position of a target more accurately.

FIG. 8 shows a target object sensing scenario 800 that includes reflections traveling along LOS paths and NLOS paths, according to aspects of the disclosure. In this example, the target object sensing scenario 800 is shown in the context of a bistatic sensing configuration in which a first wireless device 802 (e.g., anchor UE, gNB, roadside unit, LMF, SnMF (e.g. a core network entity that is responsible for managing and coordinating sensing sessions, which can be a standalone entity or part of an existing entity such as the LMF), or other sensing entity) is configured for transmitting the ranging signals (RS) for the sensing operations and the second wireless device 804 (e.g., UE, TRP, positioning reference unit (PRU), sensing reference to unit (SRU), or other sensing node) is configured for measuring the ranging signals. The objective of the target object sensing scenario 800 is to obtain information relating to the target object 806. Such information may include the location of the target object 806, physical characteristics of the target object 806, and/or other target object information. In addition to the wireless devices 802, 804 and the target object 806, the target object sensing scenario 800 also includes reflective obstructions 808 and 810 (shown in this example as walls).

Different types of radio propagation paths are shown in FIG. 8, according to aspects of the disclosure. These radio propagation paths may be characterized as “target paths” or “scattering paths” based on whether a reflection received by the wireless device 804 is reflected from the target object 806. Radio propagation paths that include reflections from the target object 806 that are received by the wireless device 804 may be characterized as target propagation paths, while radio propagation paths in which the reflections received by the wireless device 804 do not contain reflections from the target object 806 may be characterized as scatter propagation paths.

In this example, wireless device 802 is shown as transmitting reference signals (RS) along transmission propagation paths 812, 814, 816, 818, and 820. Wireless device 804 is shown as receiving reflected RS along reflection propagation paths 822, 824, 826, 828, and 830. Additionally, the wireless device 804 receives RS directly from the wireless device 802 along a LOS propagation path 820 (direct propagation path).

RS signals transmitted along transmission propagation path 812 are reflected by the reflective obstruction 808 directly along reflection propagation path 822 to the wireless device 804. As such, the propagation path defined by the transmission propagation path 812 and reflection propagation path 822 may be characterized as a scattering path (first scattering path). RS signals transmitted along transmission propagation path 814 are also reflected by the reflective obstruction 808, but are reflected toward the target object 806 along propagation reflection path 832 and subsequently reflected by the target object 806 to the wireless device 804 along reflection propagation path 824. As such, the propagation path defined by the transmission propagation path 814 and reflection propagation paths 832 and 826 may be characterized as a target path (first target path). RS signals transmitted along transmission propagation path 816 are reflected directly from the target object 806 along reflection propagation path 824. As such, the propagation path defined by the transmission propagation path 816 and reflection propagation path 822 may be characterized as a target path (second target path). RS propagating along reflection propagation path 832 may also be propagated along reflection propagation path 834 toward the reflective obstruction 810 and along reflection propagation path 828 toward the wireless device 804. Since the reflected RS received along reflection propagation path 828 have been reflected by the target object 806 at some point along the reflection propagation path 834, the propagation path defined by the transmission propagation path 814, the reflection propagation path 834, and the reflection propagation path 828 may be characterized as a target path (third target path). RS signals propagating along transmission propagation path 818 are reflected by the reflective obstruction 810 along reflection propagation path 830 directly to the wireless device 804. As such, the propagation path defined by the transmission propagation path 818 and reflection propagation path 830 may be characterized as a scattering path (second scattering path).

The wireless device 804 may use various manners of determining that an RS has propagated along a target path. In an aspect, the wireless device 804 may use a Moving Target Indicator (MTI) filter to filter out clutter and designate RF signals received with non-zero Doppler shifts as being associated with a target path. In an aspect, the wireless device 804 may compare detected RS signals with RS signals detected in the absence of any target object to identify target paths. In an aspect, the wireless device 804 may use machine-learning-based approaches to differentiate between target paths and clutter paths.

A target path may be further characterized as being a LOS target path or an NLOS target path. With reference to FIG. 8, the first target path (propagation paths 816 and 824) is a LOS target path since the RS transmitted by the first wireless device 802 is reflected directly from the target object 806 to the second wireless device 804. However, the second target path (propagation paths 814, 832, 826) and third target path (propagation paths 814, 832, 834, 828) may be characterized as NLOS target paths. More particularly, the RS signal propagating along transmission propagation path 814 is reflected by the reflective obstruction 808 before being reflected by the target object 806 along reflection propagation path 826. Likewise, the RS propagating from the target object 806 along reflection propagation path 834 is reflected by the reflective obstruction 810 before being received by the wireless device 804 along reflection propagation path 828.

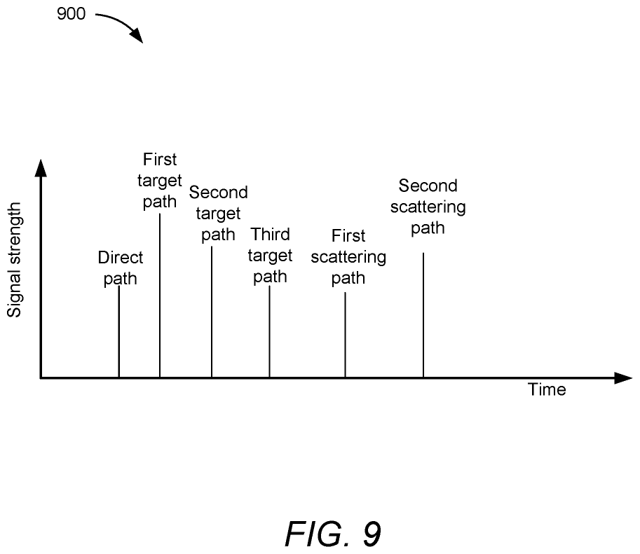

FIG. 9 is a graph 900 illustrating an example of the relative signal strength and reception times for RS propagating along the various signal paths shown in FIG. 8.

In accordance with certain aspects of the disclosure, a sensing node (e.g., wireless device 804) may indicate to a sensing entity (e.g., wireless device 802) whether RS measurements reported by the sensing node are associated with a LOS target path or NLOS target path. The capability reporting, configuration operation, sensing an propagation path reporting may be implemented in a manner similar to the exchange shown in FIG. 7 and may be implemented as part of the LPP communications.

In an aspect, the sensing node may indicate its LOS/NLOS target path characterization capabilities to the sensing entity. The reported characterization capabilities may be based on the capability of the sensing node to execute a variety of RF sensing measurements/techniques. Such measurement and technique capabilities may include the capability of obtaining 1) target path TOA measurements, 2) target path RSRP/RSPPP measurements, 3) target path Rx-Tx time difference measurements, 4) target path Doppler measurements, or 5) any combination thereof.

In an aspect, the sensing node may have the capability of reporting an indication of the likelihood that a target path is an LOS target path using a dedicated information element or other dedicated indicator (e.g., T-LOS-NLOS). In an aspect, the sensing node may have the capability of reporting the T-LOS-NLOS as a Boolean value (e.g., flag), indicating that the target path is likely an LOS target path or NLOS target path. In an aspect, the sensing node may have the capability of reporting the T-LOS-NLOS indicator as a soft value (e.g., integer) having a value indicating the likelihood that the target path is an LOS target path or NLOS target path. The characterization capabilities reported to the sensing entity may be provided by the sensing node in response to a characterization capability request from the sensing entity or can be reported in an unsolicited report.

The characterization capabilities reported by the sensing node may also indicate the granularity supported for reporting the T-LOS-NLOS indicator. In an aspect, various granularity level capabilities may be reported. In an aspect, the T-LOS-NLOS indicator may be reported by the sensing node on a sensing node-specific basis (e.g., a UE provides the T-LOS-NLOS indicator per TRP and vice versa). In an aspect, the T-LOS-NLOS indicator may be reported by the sensing node on a resource-specific basis in which the indication is provided for individual sensing signal resources.

Based on the reported T-LOS-NLOS characterization capabilities, the sensing entity may configure the sensing node with a sensing configuration indicating the types of RS measurements to be used for the reporting as well as the type and granularity of the estimated T-LOS-NLOS indicator for the configured RS measurements.

In certain scenarios, the sensing entity may have an estimation as to whether a target path is an LOS or NLOS target path. For example, the sensing entity may be in the process of tracking various targets and have access to ancillary information (e.g., a map or Digital twin of the wireless environment). In such instances, the sensing entity itself can estimate the likelihood that a target path is a target LOS path. In an aspect, the sensing entity may determine this estimate at a resource level. In these scenarios, the sensing entity may provide the likelihood that a target path is a target LOS path to the sensing node. In turn, the sensing node may use the estimate provided by the sensing entity to assist in carrying out RS measurements or for UE-based sensing operations. In an aspect, a sensing node may indicate whether it is capable of supporting expected T-LOS-NLOS indications as well as the type and granularity of the expected T-LOS-NLOS indication supported by the sensing node.

The expected T-LOS-NLOS indications may be provided to the sensing node in a variety of different manners, according to aspects of the disclosure. In an aspect, the expected T-LOS-NLOS indications may be provided in assistance data (AD) in a unicast transmission (e.g., to a specific sensing node) or in a broadcast transmission to multiple sensing nodes (e.g., via a sensing SIB). In a broadcast transmission, the T-LOS-NLOS indications may be associated with a corresponding location indication. In an aspect, the location indication may indicate the areas/regions for which sensing nodes located in these areas are likely to have a LOS target path for sensing the target object. The expected T-LOS-NLOS indication can be granular on a per Tx beam and/or Rx beam level. In such scenarios, one TRP can be a transmission node and another TRP can be a reception node. In an aspect, the AD can indicate the expected number of target paths and the likelihood that the target paths are LOS target paths.

In accordance with certain aspects of the disclosure, sensing nodes may share their characterizations of the target paths. In an aspect, a first sensing node may share its T-LOS-NLOS AD with a second sensing node. Such sharing is particularly useful when the first sensing node has received sensing node specific LOS-NLOS AD and the second sensing node is geographically close to the first sensing node. In an aspect, the sensing entity may obtain LOS target path probabilities from a first sensing node and share that information with a second sensing node. In an aspect, the sensing entity may rely on the crowd-sourced LOS target path probabilities from a first set of sensing nodes and share that information with other sensing nodes entering the same region.

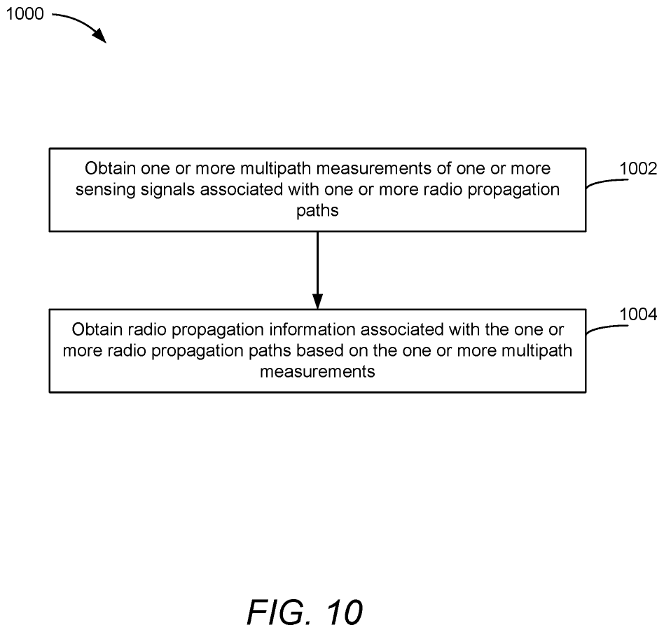

FIG. 10 illustrates an example method 1000 of wireless communication performed by a sensing node, according to aspects of the disclosure. At operation 1002, the sensing node obtains one or more multipath measurements of one or more sensing signals associated with one or more radio propagation paths. In an aspect, operation 1002 may be performed by the one or more WWAN transceivers 310, the one or more short-range wireless transceivers 320, the one or more processors 342, memory 340, and/or positioning component 348, any or all of which may be considered means for performing this operation.

At operation 1004, the sensing node obtains radio propagation paths information associated with the one or more radio propagation paths based on the one or more multipath measurements. In an aspect, operation 1004 may be performed by the one or more WWAN transceivers 310, the one or more short-range wireless transceivers 320, the one or more processors 342, memory 340, and/or positioning component 348, any or all of which may be considered means for performing this operation.

As will be appreciated, a technical advantage of the method 1000 is that a sensing entity may be provided with radio propagation paths information associated with one or more radio propagation paths that may be used to model the wireless environment in which the sensing operations take place, the construction of digital twins take place, and/or the trainings of AI/ML machine learning models can take place.

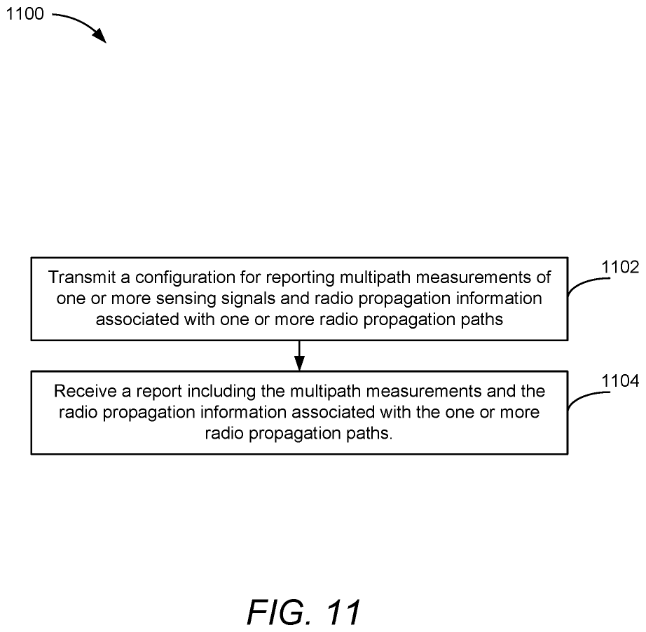

FIG. 11 illustrates an example method 1100 of wireless communication performed by a sensing entity, according to aspects of the disclosure. At operation 1102, the sensing entity transmits a configuration for reporting multipath measurements of one or more sensing signals and radio propagation paths information associated with one or more radio propagation paths. In an aspect, operation 1102 may be performed by the one or more network transceivers 398, the one or more processors 394, memory 396, and/or positioning component 398, any or all of which may be considered means for performing this operation.

At operation 1104, the sensing entity receives a report including the multipath measurements and the radio propagation paths information associated with the one or more radio propagation paths. In an aspect, operation 1104 may be performed by the one or more network transceivers 398, the one or more processors 394, memory 396, and/or positioning component 398, any or all of which may be considered means for performing this operation.

As will be appreciated, a technical advantage of the method 1100 is that a sensing entity may be provided with radio propagation paths information associated with one or more radio propagation paths that may be used to model the wireless environment in which the sensing operations take place, the construction of digital twins take place, and/or the training of AI/ML machine learning models take place.

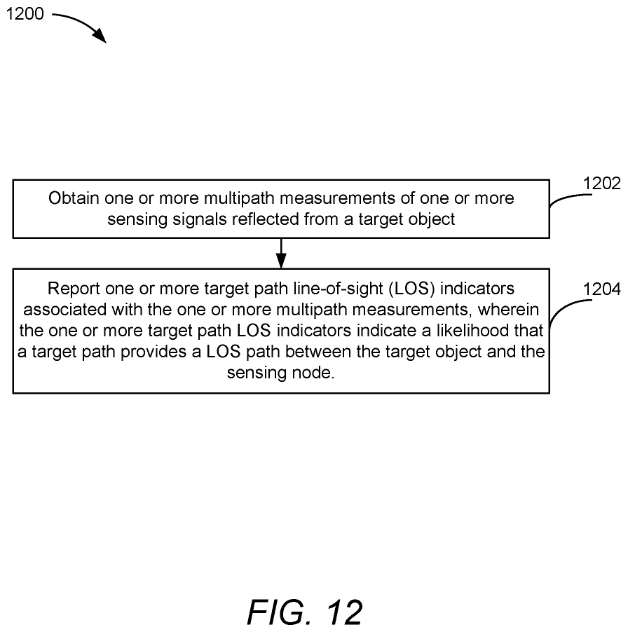

FIG. 12 illustrates an example method 1200 of wireless communication performed by a sensing node, according to aspects of the disclosure. At operation 1202, the sensing node obtains one or more multipath measurements of one or more sensing signals reflected from a target object. In an aspect, operation 1202 may be performed by the one or more WWAN transceivers 310, the one or more short-range wireless transceivers 320, the one or more processors 342, memory 340, and/or positioning component 348, any or all of which may be considered means for performing this operation.

At operation 1204, the sensing node reports one or more target path line-of-sight (LOS) indicators associated with the one or more multipath measurements, wherein the one or more target path LOS indicators indicate a likelihood that a target path provides a LOS path between the target object and the sensing node. In an aspect, operation 1204 may be performed by the one or more WWAN transceivers 310, the one or more short-range wireless transceivers 320, the one or more processors 342, memory 340, and/or positioning component 348, any or all of which may be considered means for performing this operation.

As will be appreciated, a technical advantage of the method 1200 is that the sensing entity is provided with target path LOS indicators that can be used to more accurately determine the position of a target object.

In the detailed description above it can be seen that different features are grouped together in examples. This manner of disclosure should not be understood as an intention that the example clauses have more features than are explicitly mentioned in each clause. Rather, the various aspects of the disclosure may include fewer than all features of an individual example clause disclosed. Therefore, the following clauses should hereby be deemed to be incorporated in the description, wherein each clause by itself can stand as a separate example. Although each dependent clause can refer in the clauses to a specific combination with one of the other clauses, the aspect(s) of that dependent clause are not limited to the specific combination. It will be appreciated that other example clauses can also include a combination of the dependent clause aspect(s) with the subject matter of any other dependent clause or independent clause or a combination of any feature with other dependent and independent clauses. The various aspects disclosed herein expressly include these combinations, unless it is explicitly expressed or can be readily inferred that a specific combination is not intended (e.g., contradictory aspects, such as defining an element as both an electrical insulator and an electrical conductor). Furthermore, it is also intended that aspects of a clause can be included in any other independent clause, even if the clause is not directly dependent on the independent clause.

Implementation examples are described in the following numbered clauses:

Clause 1. A method of wireless communication performed by a sensing node, comprising: obtaining one or more multipath measurements of one or more sensing signals associated with one or more radio propagation paths; and obtaining radio propagation paths information associated with the one or more radio propagation paths based on the one or more multipath measurements.

Clause 2. The method of clause 1, further comprising: reporting, to a sensing entity, the one or more multipath measurements and the radio propagation paths information associated with the one or more radio propagation paths.

Clause 3. The method of clause 2, wherein the radio propagation paths information reported to the sensing entity comprises: reflection information associated with the one or more radio propagation paths; refraction information associated with the one or more radio propagation paths; diffraction information associated with the one or more radio propagation paths; scattering information associated with the one or more radio propagation paths; sequence of propagation events information associated with the one or more radio propagation paths; quality metric information associated with the one or more radio propagation paths; or any combination thereof.

Clause 4. The method of clause 3, wherein the reflection information associated with the one or more radio propagation paths comprises: an indication that a given set of reflection information is associated with a given path of the one or more radio propagation paths; an indication of angles of reflections at a reflection point of the one or more radio propagation paths; an indication of a number of reflections associated with the one or more radio propagation paths; an indication of a location associated with the one or more radio propagation paths; or any combination thereof.

Clause 5. The method of any of clauses 3 to 4, wherein the refraction information associated with the one or more radio propagation paths comprises: an indication that the refraction information is associated with a given radio propagation path of the one or more radio propagation paths; an indication of one or more angles of refraction associated with the given radio propagation path of the one or more radio propagation paths; an indication of a number of refractions associated with the given radio propagation path of the one or more radio propagation paths; an indication of a refraction point associated with the given radio propagation path of the one or more radio propagation paths; or any combination thereof.

Clause 6. The method of any of clauses 3 to 5, wherein the diffraction information associated with the one or more radio propagation paths comprises: an indication that the diffraction information is associated with a given radio propagation path of the one or more radio propagation paths; an indication of an angle of diffraction associated with the given radio propagation path of the one or more radio propagation paths; an indication of a type of diffraction associated with the given radio propagation path of the one or more radio propagation paths; an indication of a location of one or more diffraction points associated with the given radio propagation path of the one or more radio propagation paths; or any combination thereof.

Clause 7. The method of any of clauses 3 to 6, wherein the scattering information associated with the one or more radio propagation paths comprises: an indication that the scattering information is associated with a given radio propagation path of the one or more radio propagation paths; an indication of an angle of scattering associated with the given radio propagation path of the one or more radio propagation paths; an indication of a type of scattering associated with the given radio propagation path of the one or more radio propagation paths; an indication of a number of scatterings associated with the given radio propagation path of the one or more radio propagation paths; an indication of a location of one or more scattering points associated with the given radio propagation path of the one or more radio propagation paths; or any combination thereof.

Clause 8. The method of any of clauses 3 to 7, wherein the sequence of propagation events information associated with the one or radio propagation paths comprises: an indication of an ordered sequence of propagation events associated with a given radio propagation path of the one or more radio propagation paths; an indication of locations associated with propagation events associated with the given radio propagation path of the one or more radio propagation paths; an indication of quality metrics associated with the given radio propagation path of the one or more radio propagation paths; or any combination thereof.

Clause 9. The method of any of clauses 1 to 8, further comprising: receiving a radio propagation configuration for obtaining the radio propagation paths information associated with the one or more radio propagation paths.

Clause 10. The method of clause 9, wherein the radio propagation configuration comprises: an indication of a location of the sensing node; an indication of one or more locations of one or more wireless devices used to obtain the radio propagation paths information associated with the one or more radio propagation paths; an indication of one or more locations of one or more objects associated with the one or more radio propagation paths; an indication of one or more object shapes of the one or more objects associated with the one or more radio propagation paths; an indication of one or more object orientations for the one or more objects associated with the one or more radio propagation paths; or any combination thereof.

Clause 11. The method of any of clauses 9 to 10, further comprising: reporting, to the sensing entity, an indication of radio propagation reporting capabilities of the sensing node.

Clause 12. The method of clause 11, wherein the radio propagation reporting capabilities reported to the sensing entity comprise: an indication of one or more methods used by the sensing node for reporting the radio propagation paths information; an indication of radio propagation events used by the sensing node for reporting the radio propagation paths information; an indication of one or more types of information that can be provided by the sensing node for reporting the radio propagation paths information; or any combination thereof.

Clause 13. A method of wireless communication performed by a sensing entity, comprising: transmitting a configuration for reporting multipath measurements of one or more sensing signals and radio propagation paths information associated with one or more radio propagation paths; and receiving a report including the multipath measurements and the radio propagation paths information associated with the one or more radio propagation paths.

Clause 14. The method of clause 13, further comprising: modeling a multipath radio propagation environment based on the multipath measurements and radio propagation paths information associated with the one or more radio propagation paths received in the report.

Clause 15. The method of clause 14, wherein the modeling of the multipath radio propagation environment comprises: constructing a digital twin of the multipath radio propagation environment; calibrating the digital twin of the multipath radio propagation environment; generating a dataset for training a machine learning model of the multipath radio propagation environment; augmenting the dataset used to train the machine learning model of the multipath radio propagation environment; monitoring performance of the machine learning model of the multipath radio propagation environment; or any combination thereof.

Clause 16. The method of any of clauses 13 to 15, wherein the report comprises: reflection information associated with the one or more radio propagation paths; refraction information associated with the one or more radio propagation paths; diffraction information associated with the one or more radio propagation paths; scattering information associated with the one or more radio propagation paths; sequence of propagation event information associated with the one or radio propagation paths; quality metric information associated with the one or more radio propagation paths; or any combination thereof.

Clause 17. The method of any of clauses 13 to 16, wherein the report comprises: an indication that a multipath measurement of the multipath measurements is associated with a given radio propagation path of the one or more radio propagation paths; an indication of an angle of reflection from a reflection point associated with the given radio propagation path; an indication of a number of reflections associated with the given radio propagation path; location information relating to one or more reflection points radio propagation path; or any combination thereof.

Clause 18. The method of any of clauses 13 to 17, wherein receiving the report comprises: receiving a plurality of further reports including multipath measurements and radio propagation paths information associated with one or more radio propagation paths from a plurality of sensing nodes.

Clause 19. The method of any of clauses 13 to 18, further comprising: receiving radio propagation reporting capabilities from one or more sensing nodes.

Clause 20. A method of wireless communication performed by a sensing node, comprising: obtaining one or more multipath measurements of one or more sensing signals reflected from a target object; and reporting one or more target path line-of-sight (LOS) indicators associated with the one or more multipath measurements, wherein the one or more target path LOS indicators indicate a likelihood that a target path provides a LOS path between the target object and the sensing node.

Clause 21. The method of clause 20, wherein: the one or more target path LOS indicators are reported based on time of arrival (TOA) measurements associated with the target path; reference signal received power (RSRP) information associated with the target path; reception-transmission (Rx-Tx) time difference information associated with the target path; Doppler information associated with the target path; reference signal received path power (RSRPP) information associated with the target path; or any combination thereof.

Clause 22. The method of any of clauses 20 to 21, wherein the one or more target path LOS indicators are reported as: Boolean values; an integer values; or any combination thereof.

Clause 23. The method of any of clauses 20 to 22, further comprising: reporting sensing signal measurement capabilities of the sensing node to a sensing entity.

Clause 24. The method of clause 23, wherein: the sensing signal measurement capabilities of the sensing node reported to the sensing entity indicate a capability of the sensing node to support expected target path LOS information received from the sensing entity.

Clause 25. The method of any of clauses 20 to 24, further comprising: receiving, from a second sensing node, a further target path LOS indicator indicating a likelihood that a further target path provides a LOS path between the target object and the second sensing node.

Clause 26. The method of any of clauses 20 to 25, further comprising: transmitting the one or more target path LOS indicators.

Clause 27. The method of any of clauses 20 to 26, wherein: the one or more target path LOS indicators are reported on a per sensing node basis: a per transmission-reception point (TRP) basis; a sensing signal resource basis; or any combination thereof.

Clause 28. A sensing node, comprising: one or more memories; one or more transceivers; and one or more processors communicatively coupled to the one or more memories and the one or more transceivers, the one or more processors, either alone or in combination, configured to: obtain one or more multipath measurements of one or more sensing signals associated with one or more radio propagation paths; and obtain radio propagation paths information associated with the one or more radio propagation paths based on the one or more multipath measurements.

Clause 29. The sensing node of clause 28, wherein the one or more processors, either alone or in combination, are further configured to: report, via the one or more transceivers, to a sensing entity, the one or more multipath measurements and the radio propagation paths information associated with the one or more radio propagation paths.

Clause 30. The sensing node of clause 29, wherein the radio propagation paths information reported to the sensing entity comprises: reflection information associated with the one or more radio propagation paths; refraction information associated with the one or more radio propagation paths; diffraction information associated with the one or more radio propagation paths; scattering information associated with the one or more radio propagation paths; sequence of propagation events information associated with the one or more radio propagation paths; quality metric information associated with the one or more radio propagation paths; or any combination thereof.

Clause 31. The sensing node of clause 30, wherein the reflection information associated with the one or more radio propagation paths comprises: an indication that a given set of reflection information is associated with a given path of the one or more radio propagation paths; an indication of angles of reflections at a reflection point of the one or more radio propagation paths; an indication of a number of reflections associated with the one or more radio propagation paths; an indication of a location associated with the one or more radio propagation paths; or any combination thereof.

Clause 32. The sensing node of any of clauses 30 to 31, wherein the refraction information associated with the one or more radio propagation paths comprises: an indication that the refraction information is associated with a given radio propagation path of the one or more radio propagation paths; an indication of one or more angles of refraction associated with the given radio propagation path of the one or more radio propagation paths; an indication of a number of refractions associated with the given radio propagation path of the one or more radio propagation paths; an indication of a refraction point associated with the given radio propagation path of the one or more radio propagation paths; or any combination thereof.

Clause 33. The sensing node of any of clauses 30 to 32, wherein the diffraction information associated with the one or more radio propagation paths comprises: an indication that the diffraction information is associated with a given radio propagation path of the one or more radio propagation paths; an indication of an angle of diffraction associated with the given radio propagation path of the one or more radio propagation paths; an indication of a type of diffraction associated with the given radio propagation path of the one or more radio propagation paths; an indication of a location of one or more diffraction points associated with the given radio propagation path of the one or more radio propagation paths; or any combination thereof.

Clause 34. The sensing node of any of clauses 30 to 33, wherein the scattering information associated with the one or more radio propagation paths comprises: an indication that the scattering information is associated with a given radio propagation path of the one or more radio propagation paths; an indication of an angle of scattering associated with the given radio propagation path of the one or more radio propagation paths; an indication of a type of scattering associated with the given radio propagation path of the one or more radio propagation paths; an indication of a number of scatterings associated with the given radio propagation path of the one or more radio propagation paths; an indication of a location of one or more scattering points associated with the given radio propagation path of the one or more radio propagation paths; or any combination thereof.

Clause 35. The sensing node of any of clauses 30 to 34, wherein the sequence of propagation events information associated with the one or radio propagation paths comprises: an indication of an ordered sequence of propagation events associated with a given radio propagation path of the one or more radio propagation paths; an indication of locations associated with propagation events associated with the given radio propagation path of the one or more radio propagation paths; an indication of quality metrics associated with the given radio propagation path of the one or more radio propagation paths; or any combination thereof.

Clause 36. The sensing node of any of clauses 28 to 35, wherein the one or more processors, either alone or in combination, are further configured to: receive, via the one or more transceivers, a radio propagation configuration for obtaining the radio propagation paths information associated with the one or more radio propagation paths.

Clause 37. The sensing node of clause 36, wherein the radio propagation configuration comprises: an indication of a location of the sensing node; an indication of one or more locations of one or more wireless devices used to obtain the radio propagation paths information associated with the one or more radio propagation paths; an indication of one or more locations of one or more objects associated with the one or more radio propagation paths; an indication of one or more object shapes of the one or more objects associated with the one or more radio propagation paths; an indication of one or more object orientations for the one or more objects associated with the one or more radio propagation paths; or any combination thereof.

Clause 38. The sensing node of any of clauses 36 to 37, wherein the one or more processors, either alone or in combination, are further configured to: report, via the one or more transceivers, to the sensing entity, an indication of radio propagation reporting capabilities of the sensing node.

Clause 39. The sensing node of clause 38, wherein the radio propagation reporting capabilities reported to the sensing entity comprise: an indication of one or more methods used by the sensing node for reporting the radio propagation paths information; an indication of radio propagation events used by the sensing node for reporting the radio propagation paths information; an indication of one or more types of information that can be provided by the sensing node for reporting the radio propagation paths information; or any combination thereof.

Clause 40. A sensing entity, comprising: one or more memories; one or more transceivers; and one or more processors communicatively coupled to the one or more memories and the one or more transceivers, the one or more processors, either alone or in combination, configured to: transmit, via the one or more transceivers, a configuration for reporting multipath measurements of one or more sensing signals and radio propagation paths information associated with one or more radio propagation paths; and receive, via the one or more transceivers, a report including the multipath measurements and the radio propagation paths information associated with the one or more radio propagation paths.

Clause 41. The sensing entity of clause 40, wherein the one or more processors, either alone or in combination, are further configured to: model a multipath radio propagation environment based on the multipath measurements and radio propagation paths information associated with the one or more radio propagation paths received in the report.

Clause 42. The sensing entity of clause 41, wherein the modeling of the multipath radio propagation environment comprises: constructing a digital twin of the multipath radio propagation environment; calibrating the digital twin of the multipath radio propagation environment; generating a dataset for training a machine learning model of the multipath radio propagation environment; augmenting the dataset used to train the machine learning model of the multipath radio propagation environment; monitoring performance of the machine learning model of the multipath radio propagation environment; or any combination thereof.

Clause 43. The sensing entity of any of clauses 40 to 42, wherein the report comprises: reflection information associated with the one or more radio propagation paths; refraction information associated with the one or more radio propagation paths; diffraction information associated with the one or more radio propagation paths; scattering information associated with the one or more radio propagation paths; sequence of propagation event information associated with the one or radio propagation paths; quality metric information associated with the one or more radio propagation paths; or any combination thereof.

Clause 44. The sensing entity of any of clauses 40 to 43, wherein the report comprises: an indication that a multipath measurement of the multipath measurements is associated with a given radio propagation path of the one or more radio propagation paths; an indication of an angle of reflection from a reflection point associated with the given radio propagation path; an indication of a number of reflections associated with the given radio propagation path; location information relating to one or more reflection points radio propagation path; or any combination thereof.

Clause 45. The sensing entity of any of clauses 40 to 44, wherein the one or more processors configured to receive the report comprises the one or more processors, either alone or in combination, configured to: receive, via the one or more transceivers, a plurality of further reports including multipath measurements and radio propagation paths information associated with one or more radio propagation paths from a plurality of sensing nodes.

Clause 46. The sensing entity of any of clauses 40 to 45, wherein the one or more processors, either alone or in combination, are further configured to: receive, via the one or more transceivers, radio propagation reporting capabilities from one or more sensing nodes.

Clause 47. A sensing node, comprising: one or more memories; one or more transceivers; and one or more processors communicatively coupled to the one or more memories and the one or more transceivers, the one or more processors, either alone or in combination, configured to: obtain one or more multipath measurements of one or more sensing signals reflected from a target object; and report, via the one or more transceivers, one or more target path line-of-sight (LOS) indicators associated with the one or more multipath measurements, wherein the one or more target path LOS indicators indicate a likelihood that a target path provides a LOS path between the target object and the sensing node.

Clause 48. The sensing node of clause 47, wherein: the one or more target path LOS indicators are reported based on time of arrival (TOA) measurements associated with the target path; reference signal received power (RSRP) information associated with the target path; reception-transmission (Rx-Tx) time difference information associated with the target path; Doppler information associated with the target path; reference signal received path power (RSRPP) information associated with the target path; or any combination thereof.

Clause 49. The sensing node of any of clauses 47 to 48, wherein the one or more target path LOS indicators are reported as: Boolean values; an integer values; or any combination thereof.

Clause 50. The sensing node of any of clauses 47 to 49, wherein the one or more processors, either alone or in combination, are further configured to: report, via the one or more transceivers, sensing signal measurement capabilities of the sensing node to a sensing entity.

Clause 51. The sensing node of clause 50, wherein: the sensing signal measurement capabilities of the sensing node reported to the sensing entity indicate a capability of the sensing node to support expected target path LOS information received from the sensing entity.

Clause 52. The sensing node of any of clauses 47 to 51, wherein the one or more processors, either alone or in combination, are further configured to: receive, via the one or more transceivers, from a second sensing node, a further target path LOS indicator indicating a likelihood that a further target path provides a LOS path between the target object and the second sensing node.

Clause 53. The sensing node of any of clauses 47 to 52, wherein the one or more processors, either alone or in combination, are further configured to: transmit, via the one or more transceivers, the one or more target path LOS indicators.

Clause 54. The sensing node of any of clauses 47 to 53, wherein: the one or more target path LOS indicators are reported on a per sensing node basis: a per transmission-reception point (TRP) basis; a sensing signal resource basis; or any combination thereof.

Clause 55. A sensing node, comprising: means for obtaining one or more multipath measurements of one or more sensing signals associated with one or more radio propagation paths; and means for obtaining radio propagation paths information associated with the one or more radio propagation paths based on the one or more multipath measurements.

Clause 56. The sensing node of clause 55, further comprising: means for reporting, to a sensing entity, the one or more multipath measurements and the radio propagation paths information associated with the one or more radio propagation paths.

Clause 57. The sensing node of clause 56, wherein the radio propagation paths information reported to the sensing entity comprises: reflection information associated with the one or more radio propagation paths; refraction information associated with the one or more radio propagation paths; diffraction information associated with the one or more radio propagation paths; scattering information associated with the one or more radio propagation paths; sequence of propagation events information associated with the one or more radio propagation paths; quality metric information associated with the one or more radio propagation paths; or any combination thereof.

Clause 58. The sensing node of clause 57, wherein the reflection information associated with the one or more radio propagation paths comprises: an indication that a given set of reflection information is associated with a given path of the one or more radio propagation paths; an indication of angles of reflections at a reflection point of the one or more radio propagation paths; an indication of a number of reflections associated with the one or more radio propagation paths; an indication of a location associated with the one or more radio propagation paths; or any combination thereof.

Clause 59. The sensing node of any of clauses 57 to 58, wherein the refraction information associated with the one or more radio propagation paths comprises: an indication that the refraction information is associated with a given radio propagation path of the one or more radio propagation paths; an indication of one or more angles of refraction associated with the given radio propagation path of the one or more radio propagation paths; an indication of a number of refractions associated with the given radio propagation path of the one or more radio propagation paths; an indication of a refraction point associated with the given radio propagation path of the one or more radio propagation paths; or any combination thereof.

Clause 60. The sensing node of any of clauses 57 to 59, wherein the diffraction information associated with the one or more radio propagation paths comprises: an indication that the diffraction information is associated with a given radio propagation path of the one or more radio propagation paths; an indication of an angle of diffraction associated with the given radio propagation path of the one or more radio propagation paths; an indication of a type of diffraction associated with the given radio propagation path of the one or more radio propagation paths; an indication of a location of one or more diffraction points associated with the given radio propagation path of the one or more radio propagation paths; or any combination thereof.

Clause 61. The sensing node of any of clauses 57 to 60, wherein the scattering information associated with the one or more radio propagation paths comprises: an indication that the scattering information is associated with a given radio propagation path of the one or more radio propagation paths; an indication of an angle of scattering associated with the given radio propagation path of the one or more radio propagation paths; an indication of a type of scattering associated with the given radio propagation path of the one or more radio propagation paths; an indication of a number of scatterings associated with the given radio propagation path of the one or more radio propagation paths; an indication of a location of one or more scattering points associated with the given radio propagation path of the one or more radio propagation paths; or any combination thereof.

Clause 62. The sensing node of any of clauses 57 to 61, wherein the sequence of propagation events information associated with the one or radio propagation paths comprises: an indication of an ordered sequence of propagation events associated with a given radio propagation path of the one or more radio propagation paths; an indication of locations associated with propagation events associated with the given radio propagation path of the one or more radio propagation paths; an indication of quality metrics associated with the given radio propagation path of the one or more radio propagation paths; or any combination thereof.

Clause 63. The sensing node of any of clauses 55 to 62, further comprising: means for receiving a radio propagation configuration for obtaining the radio propagation paths information associated with the one or more radio propagation paths.

Clause 64. The sensing node of clause 63, wherein the radio propagation configuration comprises: an indication of a location of the sensing node; an indication of one or more locations of one or more wireless devices used to obtain the radio propagation paths information associated with the one or more radio propagation paths; an indication of one or more locations of one or more objects associated with the one or more radio propagation paths; an indication of one or more object shapes of the one or more objects associated with the one or more radio propagation paths; an indication of one or more object orientations for the one or more objects associated with the one or more radio propagation paths; or any combination thereof.

Clause 65. The sensing node of any of clauses 63 to 64, further comprising: means for reporting, to the sensing entity, an indication of radio propagation reporting capabilities of the sensing node.

Clause 66. The sensing node of clause 65, wherein the radio propagation reporting capabilities reported to the sensing entity comprise: an indication of one or more methods used by the sensing node for reporting the radio propagation paths information; an indication of radio propagation events used by the sensing node for reporting the radio propagation paths information; an indication of one or more types of information that can be provided by the sensing node for reporting the radio propagation paths information; or any combination thereof.

Clause 67. A sensing entity, comprising: means for transmitting a configuration for reporting multipath measurements of one or more sensing signals and radio propagation paths information associated with one or more radio propagation paths; and means for receiving a report including the multipath measurements and the radio propagation paths information associated with the one or more radio propagation paths.

Clause 68. The sensing entity of clause 67, further comprising: means for modeling a multipath radio propagation environment based on the multipath measurements and radio propagation paths information associated with the one or more radio propagation paths received in the report.

Clause 69. The sensing entity of clause 68, wherein the modeling of the multipath radio propagation environment comprises: means for constructing a digital twin of the multipath radio propagation environment; means for calibrating the digital twin of the multipath radio propagation environment; means for generating a dataset for training a machine learning model of the multipath radio propagation environment; means for augmenting the dataset used to train the machine learning model of the multipath radio propagation environment; means for monitoring performance of the machine learning model of the multipath radio propagation environment; or any combination thereof.

Clause 70. The sensing entity of any of clauses 67 to 69, wherein the report comprises: reflection information associated with the one or more radio propagation paths; refraction information associated with the one or more radio propagation paths; diffraction information associated with the one or more radio propagation paths; scattering information associated with the one or more radio propagation paths; sequence of propagation event information associated with the one or radio propagation paths; quality metric information associated with the one or more radio propagation paths; or any combination thereof.

Clause 71. The sensing entity of any of clauses 67 to 70, wherein the report comprises: an indication that a multipath measurement of the multipath measurements is associated with a given radio propagation path of the one or more radio propagation paths; an indication of an angle of reflection from a reflection point associated with the given radio propagation path; an indication of a number of reflections associated with the given radio propagation path; location information relating to one or more reflection points radio propagation path; or any combination thereof.

Clause 72. The sensing entity of any of clauses 67 to 71, wherein the means for receiving the report comprises: means for receiving a plurality of further reports including multipath measurements and radio propagation paths information associated with one or more radio propagation paths from a plurality of sensing nodes.

Clause 73. The sensing entity of any of clauses 67 to 72, further comprising: means for receiving radio propagation reporting capabilities from one or more sensing nodes.

Clause 74. A sensing node, comprising: means for obtaining one or more multipath measurements of one or more sensing signals reflected from a target object; and means for reporting one or more target path line-of-sight (LOS) indicators associated with the one or more multipath measurements, wherein the one or more target path LOS indicators indicate a likelihood that a target path provides a LOS path between the target object and the sensing node.

Clause 75. The sensing node of clause 74, wherein: the one or more target path LOS indicators are reported based on time of arrival (TOA) measurements associated with the target path; reference signal received power (RSRP) information associated with the target path; reception-transmission (Rx-Tx) time difference information associated with the target path; Doppler information associated with the target path; reference signal received path power (RSRPP) information associated with the target path; or any combination thereof.

Clause 76. The sensing node of any of clauses 74 to 75, wherein the one or more target path LOS indicators are reported as: Boolean values; an integer values; or any combination thereof.

Clause 77. The sensing node of any of clauses 74 to 76, further comprising: means for reporting sensing signal measurement capabilities of the sensing node to a sensing entity.

Clause 78. The sensing node of clause 77, wherein: the sensing signal measurement capabilities of the sensing node reported to the sensing entity indicate a capability of the sensing node to support expected target path LOS information received from the sensing entity.

Clause 79. The sensing node of any of clauses 74 to 78, further comprising: means for receiving, from a second sensing node, a further target path LOS indicator indicating a likelihood that a further target path provides a LOS path between the target object and the second sensing node.

Clause 80. The sensing node of any of clauses 74 to 79, further comprising: means for transmitting the one or more target path LOS indicators.

Clause 81. The sensing node of any of clauses 74 to 80, wherein: the one or more target path LOS indicators are reported on a per sensing node basis: a per transmission-reception point (TRP) basis; a sensing signal resource basis; or any combination thereof.

Clause 82. A non-transitory computer-readable medium storing computer-executable instructions that, when executed by a sensing node, cause the sensing node to: obtain one or more multipath measurements of one or more sensing signals associated with one or more radio propagation paths; and obtain radio propagation paths information associated with the one or more radio propagation paths based on the one or more multipath measurements.

Clause 83. The non-transitory computer-readable medium of clause 82, further comprising computer-executable instructions that, when executed by the sensing node, cause the sensing node to: report, to a sensing entity, the one or more multipath measurements and the radio propagation paths information associated with the one or more radio propagation paths.

Clause 84. The non-transitory computer-readable medium of clause 83, wherein the radio propagation paths information reported to the sensing entity comprises: reflection information associated with the one or more radio propagation paths; refraction information associated with the one or more radio propagation paths; diffraction information associated with the one or more radio propagation paths; scattering information associated with the one or more radio propagation paths; sequence of propagation events information associated with the one or more radio propagation paths; quality metric information associated with the one or more radio propagation paths; or any combination thereof.

Clause 85. The non-transitory computer-readable medium of clause 84, wherein the reflection information associated with the one or more radio propagation paths comprises: an indication that a given set of reflection information is associated with a given path of the one or more radio propagation paths; an indication of angles of reflections at a reflection point of the one or more radio propagation paths; an indication of a number of reflections associated with the one or more radio propagation paths; an indication of a location associated with the one or more radio propagation paths; or any combination thereof.

Clause 86. The non-transitory computer-readable medium of any of clauses 84 to 85, wherein the refraction information associated with the one or more radio propagation paths comprises: an indication that the refraction information is associated with a given radio propagation path of the one or more radio propagation paths; an indication of one or more angles of refraction associated with the given radio propagation path of the one or more radio propagation paths; an indication of a number of refractions associated with the given radio propagation path of the one or more radio propagation paths; an indication of a refraction point associated with the given radio propagation path of the one or more radio propagation paths; or any combination thereof.

Clause 87. The non-transitory computer-readable medium of any of clauses 84 to 86, wherein the diffraction information associated with the one or more radio propagation paths comprises: an indication that the diffraction information is associated with a given radio propagation path of the one or more radio propagation paths; an indication of an angle of diffraction associated with the given radio propagation path of the one or more radio propagation paths; an indication of a type of diffraction associated with the given radio propagation path of the one or more radio propagation paths; an indication of a location of one or more diffraction points associated with the given radio propagation path of the one or more radio propagation paths; or any combination thereof.

Clause 88. The non-transitory computer-readable medium of any of clauses 84 to 87, wherein the scattering information associated with the one or more radio propagation paths comprises: an indication that the scattering information is associated with a given radio propagation path of the one or more radio propagation paths; an indication of an angle of scattering associated with the given radio propagation path of the one or more radio propagation paths; an indication of a type of scattering associated with the given radio propagation path of the one or more radio propagation paths; an indication of a number of scatterings associated with the given radio propagation path of the one or more radio propagation paths; an indication of a location of one or more scattering points associated with the given radio propagation path of the one or more radio propagation paths; or any combination thereof.

Clause 89. The non-transitory computer-readable medium of any of clauses 84 to 88, wherein the sequence of propagation events information associated with the one or radio propagation paths comprises: an indication of an ordered sequence of propagation events associated with a given radio propagation path of the one or more radio propagation paths; an indication of locations associated with propagation events associated with the given radio propagation path of the one or more radio propagation paths; an indication of quality metrics associated with the given radio propagation path of the one or more radio propagation paths; or any combination thereof.

Clause 90. The non-transitory computer-readable medium of any of clauses 82 to 89, further comprising computer-executable instructions that, when executed by the sensing node, cause the sensing node to: receive a radio propagation configuration for obtaining the radio propagation paths information associated with the one or more radio propagation paths.

Clause 91. The non-transitory computer-readable medium of clause 90, wherein the radio propagation configuration comprises: an indication of a location of the sensing node; an indication of one or more locations of one or more wireless devices used to obtain the radio propagation paths information associated with the one or more radio propagation paths; an indication of one or more locations of one or more objects associated with the one or more radio propagation paths; an indication of one or more object shapes of the one or more objects associated with the one or more radio propagation paths; an indication of one or more object orientations for the one or more objects associated with the one or more radio propagation paths; or any combination thereof.

Clause 92. The non-transitory computer-readable medium of any of clauses 90 to 91, further comprising computer-executable instructions that, when executed by the sensing node, cause the sensing node to: report, to the sensing entity, an indication of radio propagation reporting capabilities of the sensing node.

Clause 93. The non-transitory computer-readable medium of clause 92, wherein the radio propagation reporting capabilities reported to the sensing entity comprise: an indication of one or more methods used by the sensing node for reporting the radio propagation paths information; an indication of radio propagation events used by the sensing node for reporting the radio propagation paths information; an indication of one or more types of information that can be provided by the sensing node for reporting the radio propagation paths information; or any combination thereof.

Clause 94. A non-transitory computer-readable medium storing computer-executable instructions that, when executed by a sensing entity, cause the sensing entity to: transmit a configuration for reporting multipath measurements of one or more sensing signals and radio propagation paths information associated with one or more radio propagation paths; and receive a report including the multipath measurements and the radio propagation paths information associated with the one or more radio propagation paths.

Clause 95. The non-transitory computer-readable medium of clause 94, further comprising computer-executable instructions that, when executed by the sensing entity, cause the sensing entity to: model a multipath radio propagation environment based on the multipath measurements and radio propagation paths information associated with the one or more radio propagation paths received in the report.

Clause 96. The non-transitory computer-readable medium of clause 95, wherein the modeling of the multipath radio propagation environment comprises: constructing a digital twin of the multipath radio propagation environment; calibrating the digital twin of the multipath radio propagation environment; generating a dataset for training a machine learning model of the multipath radio propagation environment; augmenting the dataset used to train the machine learning model of the multipath radio propagation environment; monitoring performance of the machine learning model of the multipath radio propagation environment; or any combination thereof.

Clause 97. The non-transitory computer-readable medium of any of clauses 94 to 96, wherein the report comprises: reflection information associated with the one or more radio propagation paths; refraction information associated with the one or more radio propagation paths; diffraction information associated with the one or more radio propagation paths; scattering information associated with the one or more radio propagation paths; sequence of propagation event information associated with the one or radio propagation paths; quality metric information associated with the one or more radio propagation paths; or any combination thereof.

Clause 98. The non-transitory computer-readable medium of any of clauses 94 to 97, wherein the report comprises: an indication that a multipath measurement of the multipath measurements is associated with a given radio propagation path of the one or more radio propagation paths; an indication of an angle of reflection from a reflection point associated with the given radio propagation path; an indication of a number of reflections associated with the given radio propagation path; location information relating to one or more reflection points radio propagation path; or any combination thereof.

Clause 99. The non-transitory computer-readable medium of any of clauses 94 to 98, wherein the computer-executable instructions that, when executed by the sensing entity, cause the sensing entity to receive the report comprise computer-executable instructions that, when executed by the sensing entity, cause the sensing entity to: receive a plurality of further reports including multipath measurements and radio propagation paths information associated with one or more radio propagation paths from a plurality of sensing nodes.

Clause 100. The non-transitory computer-readable medium of any of clauses 94 to 99, further comprising computer-executable instructions that, when executed by the sensing entity, cause the sensing entity to: receive radio propagation reporting capabilities from one or more sensing nodes.

Clause 101. A non-transitory computer-readable medium storing computer-executable instructions that, when executed by a sensing node, cause the sensing node to: obtain one or more multipath measurements of one or more sensing signals reflected from a target object; and report one or more target path line-of-sight (LOS) indicators associated with the one or more multipath measurements, wherein the one or more target path LOS indicators indicate a likelihood that a target path provides a LOS path between the target object and the sensing node.

Clause 102. The non-transitory computer-readable medium of clause 101, wherein: the one or more target path LOS indicators are reported based on time of arrival (TOA) measurements associated with the target path; reference signal received power (RSRP) information associated with the target path; reception-transmission (Rx-Tx) time difference information associated with the target path; Doppler information associated with the target path; reference signal received path power (RSRPP) information associated with the target path; or any combination thereof.

Clause 103. The non-transitory computer-readable medium of any of clauses 101 to 102, wherein the one or more target path LOS indicators are reported as: Boolean values; an integer values; or any combination thereof.

Clause 104. The non-transitory computer-readable medium of any of clauses 101 to 103, further comprising computer-executable instructions that, when executed by the sensing node, cause the sensing node to: report sensing signal measurement capabilities of the sensing node to a sensing entity.

Clause 105. The non-transitory computer-readable medium of clause 104, wherein: the sensing signal measurement capabilities of the sensing node reported to the sensing entity indicate a capability of the sensing node to support expected target path LOS information received from the sensing entity.

Clause 106. The non-transitory computer-readable medium of any of clauses 101 to 105, further comprising computer-executable instructions that, when executed by the sensing node, cause the sensing node to: receive, from a second sensing node, a further target path LOS indicator indicating a likelihood that a further target path provides a LOS path between the target object and the second sensing node.

Clause 107. The non-transitory computer-readable medium of any of clauses 101 to 106, further comprising computer-executable instructions that, when executed by the sensing node, cause the sensing node to: transmit the one or more target path LOS indicators.

Clause 108. The non-transitory computer-readable medium of any of clauses 101 to 107, wherein: the one or more target path LOS indicators are reported on a per sensing node basis: a per transmission-reception point (TRP) basis; a sensing signal resource basis; or any combination thereof.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a general purpose processor, a digital signal processor (DSP), an ASIC, a field-programmable gate array (FPGA), or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, for example, a combination of a DSP and a microprocessor, a plurality of microprocessors, one or more microprocessors in conjunction with a DSP core, or any other such configuration.

The methods, sequences and/or algorithms described in connection with the aspects disclosed herein may be embodied directly in hardware, in a software module executed by a processor, or in a combination of the two. A software module may reside in random access memory (RAM), flash memory, read-only memory (ROM), erasable programmable ROM (EPROM), electrically erasable programmable ROM (EEPROM), registers, hard disk, a removable disk, a CD-ROM, or any other form of storage medium known in the art. An example storage medium is coupled to the processor such that the processor can read information from, and write information to, the storage medium. In the alternative, the storage medium may be integral to the processor. The processor and the storage medium may reside in an ASIC. The ASIC may reside in a user terminal (e.g., UE). In the alternative, the processor and the storage medium may reside as discrete components in a user terminal.

In one or more example aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

While the foregoing disclosure shows illustrative aspects of the disclosure, it should be noted that various changes and modifications could be made herein without departing from the scope of the disclosure as defined by the appended claims. For example, the functions, steps and/or actions of the method claims in accordance with the aspects of the disclosure described herein need not be performed in any particular order. Further, no component, function, action, or instruction described or claimed herein should be construed as critical or essential unless explicitly described as such. Furthermore, as used herein, the terms “set,” “group,” and the like are intended to include one or more of the stated elements. Also, as used herein, the terms “has,” “have,” “having,” “comprises,” “comprising,” “includes,” “including,” and the like does not preclude the presence of one or more additional elements (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”) or the alternatives are mutually exclusive (e.g., “one or more” should not be interpreted as “one and more”). Furthermore, although components, functions, actions, and instructions may be described or claimed in the singular, the plural is contemplated unless limitation to the singular is explicitly stated. Accordingly, as used herein, the articles “a,” “an,” “the,” and “said” are intended to include one or more of the stated elements. Additionally, as used herein, the terms “at least one” and “one or more” encompass “one” component, function, action, or instruction performing or capable of performing a described or claimed functionality and also “two or more” components, functions, actions, or instructions performing or capable of performing a described or claimed functionality in combination.

What is claimed is:

1. A method of wireless communication performed by a sensing node, comprising:
obtaining one or more multipath measurements of one or more sensing signals associated with one or more radio propagation paths; and
obtaining radio propagation paths information associated with the one or more radio propagation paths based on the one or more multipath measurements.

2. The method of claim 1, further comprising:
reporting, to a sensing entity, the one or more multipath measurements and the radio propagation paths information associated with the one or more radio propagation paths.

3. The method of claim 1, further comprising:
receiving a radio propagation configuration for obtaining the radio propagation paths information associated with the one or more radio propagation paths.

4. A sensing node, comprising:
one or more memories;
one or more transceivers; and
one or more processors communicatively coupled to the one or more memories and the one or more transceivers, the one or more processors, either alone or in combination, configured to:
obtain one or more multipath measurements of one or more sensing signals associated with one or more radio propagation paths; and
obtain radio propagation paths information associated with the one or more radio propagation paths based on the one or more multipath measurements.

5. The sensing node of claim 4, wherein the one or more processors, either alone or in combination, are further configured to:
report, via the one or more transceivers, to a sensing entity, the one or more multipath measurements and the radio propagation paths information associated with the one or more radio propagation paths.

6. The sensing node of claim 5, wherein the radio propagation paths information reported to the sensing entity comprises:
reflection information associated with the one or more radio propagation paths;
refraction information associated with the one or more radio propagation paths;
diffraction information associated with the one or more radio propagation paths;
scattering information associated with the one or more radio propagation paths;
sequence of propagation events information associated with the one or more radio propagation paths;
quality metric information associated with the one or more radio propagation paths; or
any combination thereof.

7. The sensing node of claim 6, wherein the reflection information associated with the one or more radio propagation paths comprises:
an indication that a given set of reflection information is associated with a given path of the one or more radio propagation paths;
an indication of angles of reflections at a reflection point of the one or more radio propagation paths;
an indication of a number of reflections associated with the one or more radio propagation paths;
an indication of a location associated with the one or more radio propagation paths; or
any combination thereof.

8. The sensing node of claim 6, wherein the refraction information associated with the one or more radio propagation paths comprises:
an indication that the refraction information is associated with a given radio propagation path of the one or more radio propagation paths;
an indication of one or more angles of refraction associated with the given radio propagation path of the one or more radio propagation paths;
an indication of a number of refractions associated with the given radio propagation path of the one or more radio propagation paths;
an indication of a refraction point associated with the given radio propagation path of the one or more radio propagation paths; or
any combination thereof.

9. The sensing node of claim 6, wherein the diffraction information associated with the one or more radio propagation paths comprises:
an indication that the diffraction information is associated with a given radio propagation path of the one or more radio propagation paths;
an indication of an angle of diffraction associated with the given radio propagation path of the one or more radio propagation paths;
an indication of a type of diffraction associated with the given radio propagation path of the one or more radio propagation paths;
an indication of a location of one or more diffraction points associated with the given radio propagation path of the one or more radio propagation paths; or
any combination thereof.

10. The sensing node of claim 6, wherein the scattering information associated with the one or more radio propagation paths comprises:
an indication that the scattering information is associated with a given radio propagation path of the one or more radio propagation paths;
an indication of an angle of scattering associated with the given radio propagation path of the one or more radio propagation paths;
an indication of a type of scattering associated with the given radio propagation path of the one or more radio propagation paths;
an indication of a number of scatterings associated with the given radio propagation path of the one or more radio propagation paths;
an indication of a location of one or more scattering points associated with the given radio propagation path of the one or more radio propagation paths; or
any combination thereof.

11. The sensing node of claim 6, wherein the sequence of propagation events information associated with the one or radio propagation paths comprises:
an indication of an ordered sequence of propagation events associated with a given radio propagation path of the one or more radio propagation paths;
an indication of locations associated with propagation events associated with the given radio propagation path of the one or more radio propagation paths;
an indication of quality metrics associated with the given radio propagation path of the one or more radio propagation paths; or
any combination thereof.

12. The sensing node of claim 4, wherein the one or more processors, either alone or in combination, are further configured to:
receive, via the one or more transceivers, a radio propagation configuration for obtaining the radio propagation paths information associated with the one or more radio propagation paths.

13. The sensing node of claim 12, wherein the radio propagation configuration comprises:
an indication of a location of the sensing node;
an indication of one or more locations of one or more wireless devices used to obtain the radio propagation paths information associated with the one or more radio propagation paths;
an indication of one or more locations of one or more objects associated with the one or more radio propagation paths;
an indication of one or more object shapes of the one or more objects associated with the one or more radio propagation paths;
an indication of one or more object orientations for the one or more objects associated with the one or more radio propagation paths; or
any combination thereof.

14. The sensing node of claim 12, wherein the one or more processors, either alone or in combination, are further configured to:
report, via the one or more transceivers, to the sensing entity, an indication of radio propagation reporting capabilities of the sensing node.

15. The sensing node of claim 14, wherein the radio propagation reporting capabilities reported to the sensing entity comprise:
an indication of one or more methods used by the sensing node for reporting the radio propagation paths information;
an indication of radio propagation events used by the sensing node for reporting the radio propagation paths information;
an indication of one or more types of information that can be provided by the sensing node for reporting the radio propagation paths information; or
any combination thereof.

16. A sensing entity, comprising:
one or more memories;
one or more transceivers; and
one or more processors communicatively coupled to the one or more memories and the one or more transceivers, the one or more processors, either alone or in combination, configured to:
transmit, via the one or more transceivers, a configuration for reporting multipath measurements of one or more sensing signals and radio propagation paths information associated with one or more radio propagation paths; and
receive, via the one or more transceivers, a report including the multipath measurements and the radio propagation paths information associated with the one or more radio propagation paths.

17. The sensing entity of claim 16, wherein the one or more processors, either alone or in combination, are further configured to:
model a multipath radio propagation environment based on the multipath measurements and radio propagation paths information associated with the one or more radio propagation paths received in the report.

18. The sensing entity of claim 17, wherein the modeling of the multipath radio propagation environment comprises:
constructing a digital twin of the multipath radio propagation environment;
calibrating the digital twin of the multipath radio propagation environment;
generate a dataset for training a machine learning model of the multipath radio propagation environment;
augmenting the dataset used to train the machine learning model of the multipath radio propagation environment;
monitor performance of the machine learning model of the multipath radio propagation environment; or
any combination thereof.

19. The sensing entity of claim 16, wherein the report comprises:
reflection information associated with the one or more radio propagation paths;
refraction information associated with the one or more radio propagation paths;
diffraction information associated with the one or more radio propagation paths;
scattering information associated with the one or more radio propagation paths;
sequence of propagation event information associated with the one or radio propagation paths;
quality metric information associated with the one or more radio propagation paths; or
any combination thereof.

20. The sensing entity of claim 16, wherein the report comprises:
an indication that a multipath measurement of the multipath measurements is associated with a given radio propagation path of the one or more radio propagation paths;
an indication of an angle of reflection from a reflection point associated with the given radio propagation path;
an indication of a number of reflections associated with the given radio propagation path;
location information relating to one or more reflection points radio propagation path; or
any combination thereof.

21. The sensing entity of claim 16, wherein the one or more processors configured to receive the report comprises the one or more processors, either alone or in combination, configured to:
receive, via the one or more transceivers, a plurality of further reports including multipath measurements and radio propagation paths information associated with one or more radio propagation paths from a plurality of sensing nodes.

22. The sensing entity of claim 16, wherein the one or more processors, either alone or in combination, are further configured to:
receive, via the one or more transceivers, radio propagation reporting capabilities from one or more sensing nodes.

23. A sensing node, comprising:
one or more memories;
one or more transceivers; and
one or more processors communicatively coupled to the one or more memories and the one or more transceivers, the one or more processors, either alone or in combination, configured to:
obtain one or more multipath measurements of one or more sensing signals reflected from a target object; and
report, via the one or more transceivers, one or more target path line-of-sight (LOS) indicators associated with the one or more multipath measurements, wherein the one or more target path LOS indicators indicate a likelihood that a target path provides a LOS path between the target object and the sensing node.

24. The sensing node of claim 23, wherein:
the one or more target path LOS indicators are reported based on time of arrival (TOA) measurements associated with the target path;
reference signal received power (RSRP) information associated with the target path;
reception-transmission (Rx-Tx) time difference information associated with the target path;
Doppler information associated with the target path;
reference signal received path power (RSRPP) information associated with the target path; or
any combination thereof.

25. The sensing node of claim 23, wherein the one or more target path LOS indicators are reported as:
Boolean values;
an integer values; or
any combination thereof.

26. The sensing node of claim 23, wherein the one or more processors, either alone or in combination, are further configured to:
report, via the one or more transceivers, sensing signal measurement capabilities of the sensing node to a sensing entity.

27. The sensing node of claim 26, wherein:
the sensing signal measurement capabilities of the sensing node reported to the sensing entity indicate a capability of the sensing node to support expected target path LOS information received from the sensing entity.

28. The sensing node of claim 23, wherein the one or more processors, either alone or in combination, are further configured to:
receive, via the one or more transceivers, from a second sensing node, a further target path LOS indicator indicating a likelihood that a further target path provides a LOS path between the target object and the second sensing node.

29. The sensing node of claim 23, wherein the one or more processors, either alone or in combination, are further configured to:
transmit, via the one or more transceivers, the one or more target path LOS indicators.

30. The sensing node of claim 23, wherein:
the one or more target path LOS indicators are reported on
a per sensing node basis:
a per transmission-reception point (TRP) basis;
a sensing signal resource basis; or
any combination thereof.
